(19) United States
(12) Patent Application Publication
(10) Pub. No.: US 2024/0320161 A1
(43) Pub. Date: Sep. 26, 2024

(54) APPARATUSES, METHODS, AND SYSTEMS FOR A DEVICE TRANSLATION LOOKASIDE BUFFER PRE-TRANSLATION INSTRUCTION AND EXTENSIONS TO INPUT/OUTPUT MEMORY MANAGEMENT UNIT PROTOCOLS

(71) Applicant: Intel Corporation, Santa Clara, CA (US)

(72) Inventors: Kaijie Guo, Shanghai (CN); Qianjun Xie, Shanghai (CN); Weigang Li, Shanghai (CN); Junyuan Wang, Shanghai (CN); Ashok Raj, Portland, OR (US); Zijuan Fan, Shanghai (CN)

(21) Appl. No.: 18/575,832

(22) PCT Filed: Aug. 20, 2021
(86) PCT No.: PCT/CN2021/113666

§ 371 Date: Dec. 30, 2023

(51) Int. Cl. G06F 12/1045; G06F 9/30

(52) U.S. Cl. CPC G06F 12/1045; G06F 9/3016; G06F 2212/50

(57) ABSTRACT

Systems, methods, and apparatuses to support a device translation lookaside buffer pre-translation instruction are described. A hardware system includes an input/output device, an input/output memory controller to perform a direct memory access of a memory for the input/output device, and a processor core separate from the input/output device and comprising a decoder circuit to decode a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device, and the execution circuit to execute the decoded single instruction according to the opcode.

### TECHNICAL FIELD

The disclosure relates generally to computer processor architecture, and, more specifically, to circuitry to implement a device translation lookaside buffer pre-translation instruction with an extension to an input/output memory management unit (IOMMU) protocol.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a block diagram of a computer system including a hardware processor coupled to a memory controller and an input/output (I/O) device coupled to an I/O memory controller according to embodiments of the disclosure.

FIG. 2 illustrates a data path pipeline flow with a device translation lookaside buffer (TLB) miss according to embodiments of the disclosure.

FIG. 3 illustrates a “push translation into a device TLB” (PUSHDTLB) instruction that causes a translation pipeline flow in parallel with a data path pipeline flow with a device TLB hit according to embodiments of the disclosure.

FIG. 4 illustrates a translation pipeline flow in a computer system including a hardware processor and an input/output (I/O) device coupled to an I/O memory controller according to embodiments of the disclosure.

FIG. 5 is a swimlane diagram illustrating operations of a method of using a PUSHDTLB instruction according to embodiments of the disclosure.

FIG. 6 illustrates a hardware processor coupled to storage that includes one or more PUSHDTLB instructions according to embodiments of the disclosure.

FIG. 7 illustrates a method of processing a PUSHDTLB instruction according to embodiments of the disclosure.

FIG. 8 illustrates an I/O memory controller (e.g., an input/output memory management unit (IOMIU)) process address space identifier (PASID) mapping structure according to embodiments of the disclosure.

FIG. 9 illustrates a requester identifier format and a device to domain mapping structure in scalable mode according to embodiments of the disclosure.

FIGS. 10A-10D illustrate a format of an extended capability register and example descriptions of the fields including a device TLB (“DT”) support field according to embodiments of the disclosure.

FIG. 11A is a block diagram illustrating a generic vector friendly instruction format and class A instruction templates thereof according to embodiments of the disclosure.

FIG. 11B is a block diagram illustrating the generic vector friendly instruction format and class B instruction templates thereof according to embodiments of the disclosure.

FIG. 12A is a block diagram illustrating fields for the generic vector friendly instruction formats in FIGS. 11A and 11B according to embodiments of the disclosure.

FIG. 12B is a block diagram illustrating the fields of the specific vector friendly instruction format in FIG. 12A that make up a full opcode field according to one embodiment of the disclosure.

FIG. 12C is a block diagram illustrating the fields of the specific vector friendly instruction format in FIG. 12A that make up a register index field according to one embodiment of the disclosure.

FIG. 12D is a block diagram illustrating the fields of the specific vector friendly instruction format in FIG. 12A that make up the augmentation operation field 1150 according to one embodiment of the disclosure.

FIG. 13 is a block diagram of a register architecture according to one embodiment of the disclosure

FIG. 14A is a block diagram illustrating both an exemplary in-order pipeline and an exemplary register renaming, out-of-order issue/execution pipeline according to embodiments of the disclosure.

FIG. 14B is a block diagram illustrating both an exemplary embodiment of an in-order architecture core and an exemplary register renaming, out-of-order issue/execution architecture core to be included in a processor according to embodiments of the disclosure.

FIG. 15A is a block diagram of a single processor core, along with its connection to the on-die interconnect network and with its local subset of the Level 2 (L2) cache, according to embodiments of the disclosure.

FIG. 15B is an expanded view of part of the processor core in FIG. 15A according to embodiments of the disclosure.

FIG. 16 is a block diagram of a processor that may have more than one core, may have an integrated memory controller, and may have integrated graphics according to embodiments of the disclosure.

FIG. 17 is a block diagram of a system in accordance with one embodiment of the present disclosure.

FIG. 18 is a block diagram of a more specific exemplary system in accordance with an embodiment of the present disclosure.

FIG. 19, shown is a block diagram of a second more specific exemplary system in accordance with an embodiment of the present disclosure.

FIG. 20, shown is a block diagram of a system on a chip (SoC) in accordance with an embodiment of the present disclosure.

FIG. 21 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. The operation includes accessing memory in certain embodiments. In certain embodiments, other devices, e.g., input/output devices, are to access memory, for example, by performing direct memory accesses to the memory via an input/output memory controller (e.g., circuit), e.g., an input/output memory management unit (IOMMU). In certain embodiments, instead of devices sending a memory access request with a virtual address (VA) of the memory, they instead send a corresponding physical address (PA) of the memory, e.g., allowing for memory virtualization for optimal memory usage and security. Certain devices operate according to a communication (e.g., bus) standard that supports read and/or write requests for a VA instead of a PA, for example, according to a Peripheral Component Interconnect Express (PCIe or PCI-e) standard. In certain embodiments, this caused the input/output memory controller (e.g., circuit) that receives the device's read/write request to translate the VA to PA, e.g., and complete the device's memory access operation (e.g., read/write).

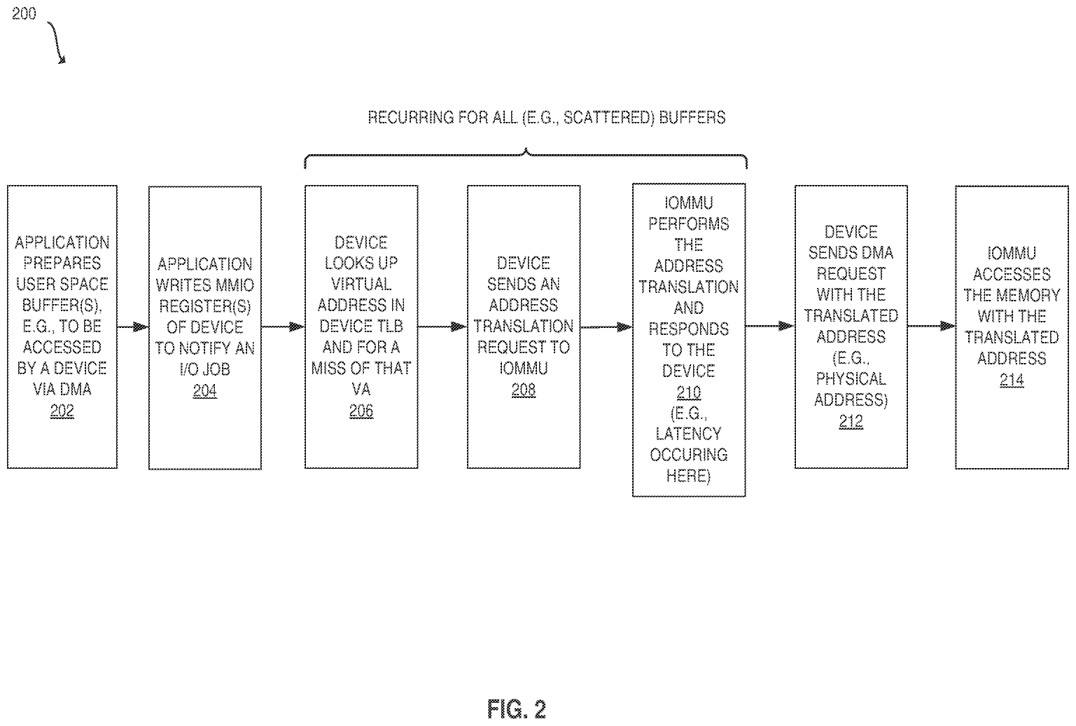

Certain devices operate according to a communication (e.g., bus) standard that supports read and/or write requests for a PA instead of a VA, for example, according to an Address Translation Services (ATS) extension to a PCI-e standard. In certain embodiments, devices that operate according to a communication (e.g., bus) standard that supports read and/or write requests for a PA instead of a VA allows those devices to request VA to PA address translations from a translation agent, such as an IOMMU. In certain embodiments, this allows a device to store the resulting translations internally, for example, in a device translation lookaside buffer (DevTLB), and directly use the resulting PA to access memory, e.g., either via a PCI-e interface or via a cache-coherent interface such as, but not limited to, Compute Express Link (CXL). However, e.g., as discussed in reference to FIG. 2 below, a miss for a lookup of a PA for a VA in the device TLB by the device (e.g., without action by the processor core(s)) causes an input/output memory controller (e.g., IOMMU) to perform a page table walk (e.g., nested page table walk) to determine a translation and this page table walk and the (e.g., ATS) translation/completion messages have delay and will degrade I/O performance in certain embodiments. To obtain the best performance by utilizing a device TLB (e.g., according to ATS), an application would need to ensure the same user space buffer is used for I/O requests, but that is not typically the case in real world. If an application frequently allocates new memory, the input/output memory controller (e.g., IOMMU) frequently performs (e.g., nested) page table walks (e.g., and sends (e.g., ATS) corresponding data packets) in order to translate the virtual addresses in certain embodiments.

Embodiments herein are directed to instructions that overcome these problems by causing an input/output memory controller (e.g., IOMMU) to pre-translate a virtual address and populate a device TLB (DevTLB) of the (e.g., PCI) device, e.g., before the device launches a direct memory access (DMA) job. Embodiments herein are directed to instructions that overcome these problems by using a new (e.g., PCI) message to enable an input/output memory controller (e.g., IOMMU) to pre-translate a virtual address and populate a device TLB (DevTLB) of the (e.g., PCI) device, e.g., before the device launches a direct memory access (DMA) job.

The instructions disclosed herein are improvements to the functioning of a processor (e.g., of a computer) itself. An instruction decode circuit (e.g., a decoder) not having such an instruction as a part of its instruction set would not decode as discussed herein. An execution circuit not having such an instruction as a part of its instruction set would not execute as discussed herein. For example, a single instruction that, when a processor decodes the single instruction into a decoded instruction and that decoded instruction is executed by the processor, causes the processor to store a virtual address to physical address mapping into a translation lookaside buffer within an input/output device, is an improvement to the functioning of the processor (e.g., of a computer) itself.

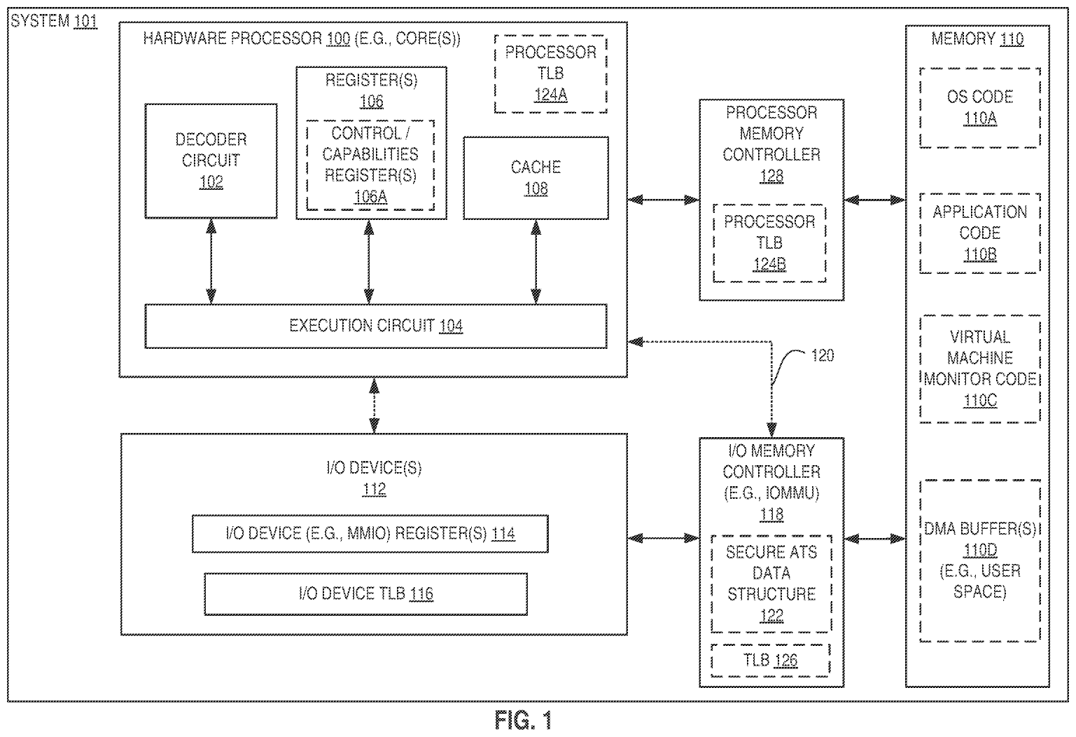

FIG. 1 illustrates a block diagram of a computer system 101 including a hardware processor 100 coupled to a memory controller 128 and an input/output (I/O) device 112 coupled to an I/O memory controller (e.g., IOMMU) 118 according to embodiments of the disclosure.

Depicted hardware processor 100 includes a hardware decoder circuit 102 (e.g., decode unit) and a hardware execution circuit 104 (e.g., execution unit). Depicted hardware processor 100 includes register(s) 106, e.g., control and/or capabilities register(s) 106A (e.g., model-specific register(s) (MSR(s)). Registers may include one or more of registers to access (e.g., load and/or store) data in, e.g., additionally or alternatively to access (e.g., load or store) of data in memory 110. Depicted hardware processor 100 includes cache 108. Cache may include one or more cache banks to access (e.g., load and/or store) data in, e.g., additionally or alternatively to access (e.g., load or store) of data in memory 110 and/or register(s) 106.

In certain embodiments, a (e.g., data and/or instruction) translation lookaside buffer (TLB) in included for processor 100, for example, TLB 124A within processor 100 and/or TLB 124B of system 101 outside of processor 100. In certain embodiments, I/O memory controller 118 (e.g., IOMMU) (e.g., shared by a plurality of devices 112) includes an I/O memory controller (e.g., IOMMU) TLB 126 (e.g., shared by a plurality of devices 112). In certain embodiments, device TLB 116 is separate (e.g., not sharing an entries with) other TLBs (e.g., TLB 126, TLB 124A, and/or TLB 124B).

In certain embodiments, system 101 includes a processor memory controller 128 to allow processor 100 (e.g., core(s)) to access memory 110 and (e.g., separately from processor memory controller 128 and/or hardware processor 100) an I/O memory controller (e.g., IOMWU) 118 to allow I/O device(s) 112 to access memory 110. In certain embodiments, I/O memory controller (e.g., IOMMU) 118 services DIA request(s) to memory from I/O device(s) 112. In certain embodiments, I/O device(s) 112 include a network interface card (NIC), graphics processor unit (GPU), an accelerator (e.g., an accelerator that secures and routes Internet traffic, provides cryptographic acceleration, and/or provides compression/decompression capabilities), or any combinations thereof.

In certain embodiments, I/O device(s) 112 includes device register(s) 114, e.g., including a set of memory mapped I/O (MIMO) registers in the device hardware, e.g., which are mapped to the host memory space by the peripheral (e.g., PCIe) bus(es). In certain embodiments, I/O device(s) 112 includes an I/O device TLB 116, e.g., separate from any other TLB in the system 101. In certain embodiments, a device does not share (or shares in other embodiments) its device TLB with other device(s). In certain embodiments, the device TLB 116 stores a plurality of virtual address to physical address mappings for that device, e.g., into one or more DIA buffers 110D that are allocated for device(s).

In certain embodiments, I/O memory controller 118 includes a secure (e.g., ATS) data structure (e.g., table) 122, for example, to allow or deny a (e.g., PCI) device to access a translated physical address according to a corresponding entry (e.g., an entry that is also created by execution of a PUSHDTLB instruction).

In certain embodiments, hardware processor 100 communicates with I/O memory controller 118 via a (e.g., reserved) path 120, e.g., separate from processor memory controller 128. In certain embodiments, hardware processor 100 communicates with I/O memory controller 118 via a register, e.g., within I/O memory controller 118.

In certain embodiments, memory 110 includes (e.g., store) one or more of (e.g., any combination of) the following software: operating system (OS) code 110A, application code 110B, virtual machine monitor code 110C, direct memory access (DIA) buffer(s) 110D (e.g., in user space as opposed to in supervisor space), or any combination thereof. Application code 110B may be a respective user program.

Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain embodiments herein.

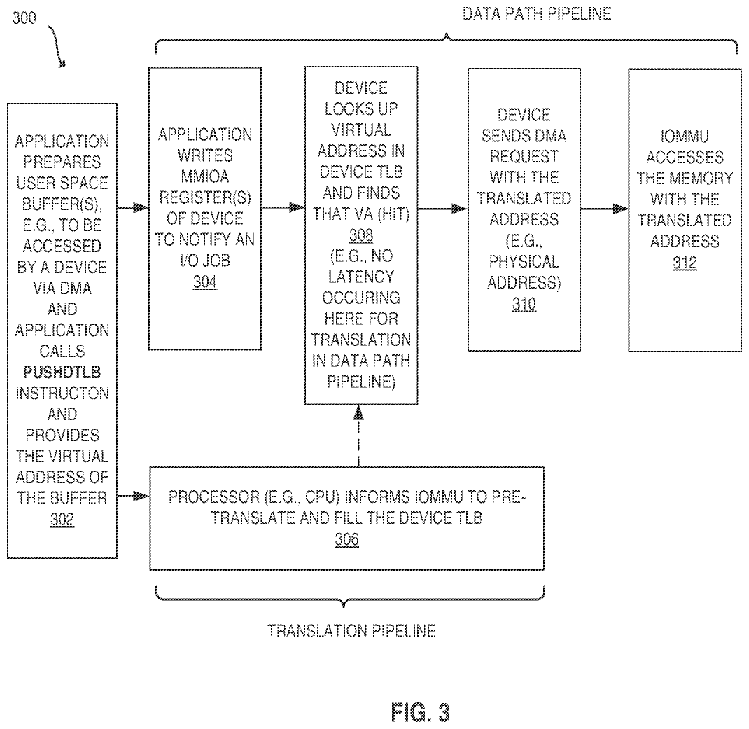

In certain embodiments, hardware decoder 102 receives an (e.g., single) instruction (e.g., macro-instruction) and decodes the instruction, e.g., into micro-instructions and/or micro-operations. In certain embodiments, hardware execution circuit 104 executes the decoded instruction (e.g., macro-instruction) to perform an operation or operations. For example, an instruction to be decoded by decoder circuit 102 and for the decoded instruction to be executed by execution circuit 104 may be any instruction discussed herein, e.g., in FIGS. 3-7.

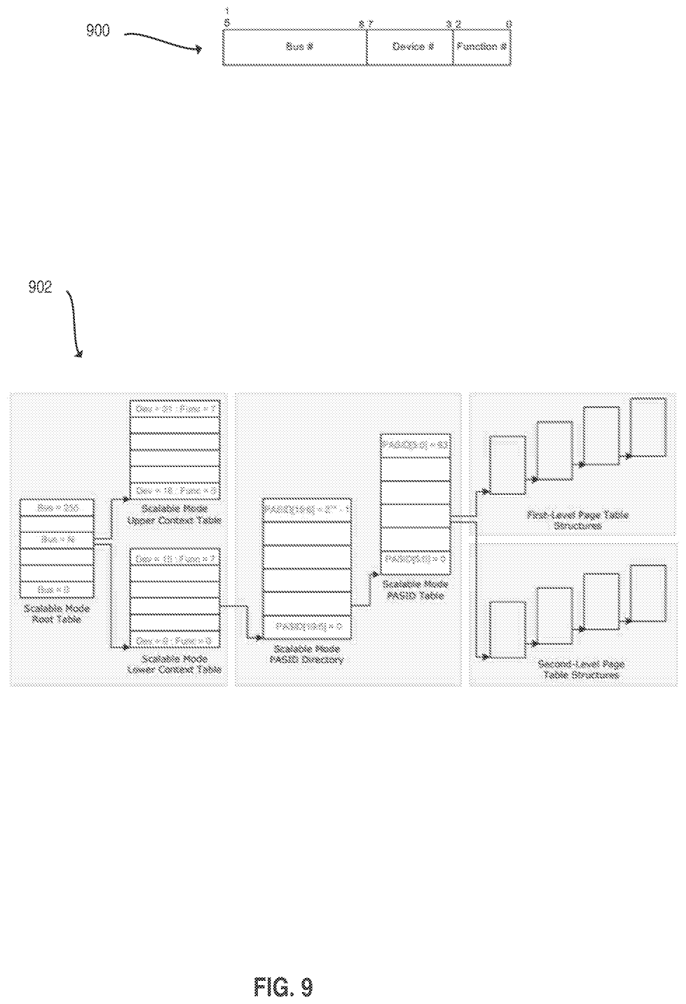

Certain I/O memory controllers (e.g., IOMMUs) (e.g., in Scalable Mode as discussed below in reference to FIG. 9) provide a shared virtual memory (SVM) that allows IO devices to access memory using the virtual address (VA) in the DMA requests (e.g., with a process address space identifier (PASID) prefix). In certain embodiments, I/O memory controller (e.g., IOMMU) translates a VA to a corresponding physical address (PA) by a first level (e.g., x86) page table with or without a second level IOMMU table, for example, in host mode, I/O memory controller (e.g., IOMMU) identifies the PASID and host VA (HVA) from the DMA request and locates the first level (e.g., x86) page table from the PASID entry (e.g., and the I/O memory controller performs a page table walk to translate the HVA to host PA (HPA)) and/or in guest mode, I/O memory controller (e.g., IOMMU) identifies the PASID and guest VA (GVA) from the DMA request and finds both the first level (e.g., x86) page table and second level (e.g., IOMMU) table from the PASID entry (e.g., and the I/O memory controller (e.g., IOMMU) performs a nested page table walk to translate GVA to HPA).

In certain embodiments, I/O memory controller (e.g., IOMMU) pushes a translation into built-in IOTLB after a successful (e.g., nested) page table walk.

In certain embodiments, a system (e.g., operating according to a standard such as, but not limited to ATS as defined by PCI— Special Interest Group (SIG) allows a (e.g., “PCI”) device to build a device TLB (DevTLB) to offload the translations (e.g., translation cache) of IOTLB from IOMMU to the DevTLB.

In certain embodiments, ATS defines protocols that (i) (e.g., PCI) device sends translation request to the I/O memory controller (e.g., IOMMU) to translate a VA, I/O memory controller (e.g., IOMMU) sends translation completion to (e.g., PCI) device containing translated PA, and I/O memory controller (e.g., IOMMU) sends invalidate request to (e.g., PCI) device if the (e.g., DMA) buffer no longer resides in system memory (e.g., when memory is freed or page out).

In certain embodiments, when a (e.g., PCI) device with (e.g., ATS) device TLB capability is to request a memory access with a VA, the device itself performs the VA to PA translation by looking in the DevTLB using the VA (e.g., and PASID) as a key, for example, if (i) there is a hit (e.g., there is an active VA to PA mapping for that VA) in the DevTLB, the device retrieves the PA from DevTLB and sends DMA request containing the PA, e.g., with address type (AT) set to translated address (e.g., but I/O memory controller (e.g., IOMMU) does not translate address for DMA packets contains Translated Address) and/or (ii) there is a miss (e.g., there is not an active VA to PA mapping for that VA) in the DevTLB, the device sends a translation request(s) to the I/O memory controller (e.g., IOMMU), e.g., and if the translation is successful, push the translation into the DevTLB and send the DMA request(s) containing the PA (e.g., translated address).

FIG. 2 illustrates a data path pipeline flow 200 with a device translation lookaside buffer (TLB) miss according to embodiments of the disclosure. Flow 200 includes, at 202, an application (e.g., software) preparing user space buffer(s), e.g., to be accessed by a device via DMA. Flow 200 includes, at 204, application (e.g., via execution of the application's instruction(s) on a processor core) writing MMIO register(s) of device (e.g., MMIO register(s) 114 of I/O device 112 in FIG. 1) to notify an I/O job. Flow 200 includes, at 206, device performing a lookup of a virtual address (VA) of that I/O job in device TLB and for a miss of that virtual address in the device TLB, proceeding to 208 (e.g., and for a hit for that virtual address in the device TLB, performing a DMA at the PA corresponding to that VA in the memory). Flow 200 includes, at 208, for the miss of that virtual address in the device TLB, the device sending an address translation request for that virtual address to I/O memory controller (e.g., IOMMU). Flow 200 includes, at 210, in response to the address translation request for that virtual address, the I/O memory controller (e.g., IOMMU) performing the address translation, e.g., and responding to the device (e.g., with the corresponding physical address from the address translation). In certain embodiments, significant latency is imparted for a pending memory access request by these communications for the miss and the corresponding lookup. In certain embodiments, an I/O job includes multiple virtual addresses that are misses in the device TLB, and operations at 206, 208, and 210 are repeated for each of those misses (e.g., each VA). Flow 200 includes, at 212, the device sending a DMA request with the translated address (e.g., physical address) to be serviced (e.g., sending the request to the I/O memory controller (e.g., IOMMU)). Flow 200 includes, at 214, the I/O memory controller (e.g., IOMMU)) accessing the memory with the translated address (e.g., the corresponding physical address from the address translation).

In certain embodiments, both I/O memory controller (e.g., IOMMU) page table walk translation (especially nested page table walk) and ATS translation/completion messages have delay and will degrade I/O performance. In certain embodiments, to get the best performance (e.g., by utilizing ATS), an application needs to ensure the same user space buffer is used for I/O requests, but that is not the case in real world, e.g., if the application frequently allocates new memory, I/O memory controller (e.g., IOMMU) and ATS have to frequently perform (nested) page table walk and send ATS packets in order to translate the virtual addresses. In certain embodiments, a (e.g., nested) page table walk following a TLB miss takes a plurality (e.g., 24) memory accesses. In certain embodiments, (e.g., PCIe ATS) translation/completion messages following a TLB miss takes numerous (e.g., hundreds of) cycles, e.g., depending on the link speed, bus hierarchy, and lane configuration.

In one embodiment, for a single request, the worst-case scenario of extra delay caused by IOMMU is (MEMORY ACCESSES*CYCLE_OF_MEM_LOOKUP+2*CYCLE_OF_PCI_TRANSACTION). Cumulatively, this is thousands of cycles per I/O request in certain embodiments.

Embodiments herein eliminate the delay of I/O memory controller (e.g., IOMMU) translation (e.g., page table walk) and/or the delay for ATS communication from I/O pipeline, to improve overall IO performance, for devices with ATS capability.

In certain embodiments, I/O memory controller (e.g., IOMMU) 118 provides a TLB (e.g., IOTLB) 126 to cache translated address in order to prevent duplicated translation, for example, but that TLB only works if a virtual address has been translated before and cached in the IOTLB, which is not the case in certain embodiments where applications allocate new memory for each request, or cache (e.g., translation) is invalidated in IOTLB due to congestion.

In certain embodiments, a system (e.g., platform) implements a First-Level Page Walk Cache (FLPWC) and/or Second-Level Page Walk Cache (SLPWC) to reduce the overall time for a nested translation, however, FLPWC and SLPWC still have latency with limitations and not guaranteed to hit every time in certain embodiments.

Certain embodiments herein a directed to a new (e.g., macro) instruction, for example, along with a new (e.g., PCI) message to command an I/O memory controller (e.g., IOMMU) to pre-translate a virtual address and populate that translation into the device TLB of the (e.g., PCI) device (e.g., “warm up” of the device TLB), e.g., before the (e.g., PCI) device launches a DMA job. In certain embodiments, the new instruction is referred to as the mnemonic of PUSHDTLB (Push a translation into Device TLB), e.g., taking a virtual address as operand. In certain embodiments, the PUSHDTLB instruction is called by an application, e.g., and executed asynchronously. Certain embodiments herein define a new (e.g., PCI) message to allow an I/O memory controller (e.g., IOMMU) to inform an I/O (e.g., PCI) device of a VA to PA translation (optionally with PASID). In certain embodiments, this new (e.g., PCI) message is referred as a Push TLB message, and it can be either a standalone message or an extension to a (e.g., ATS) protocol, e.g., where this message is directly sent from the I/O memory controller (e.g., IOMMU) to the PCI device. In certain embodiments, a system (e.g., processor) that supports the improved functionality discussed herein includes one or more capability flags to indicate that functionality.

Embodiments herein allow an I/O (e.g., PCI) device to obtain a translation in the device TLB for buffers to be used in a DMVA ahead of the DMA request, e.g., when the I/O (e.g., PCI) device receives job that requires a DMA, the translation result is already in the device TLB and can send the DMA request with the translated address without the need to ask (e.g., send ATS translation request to) the I/O memory controller (e.g., IOMMU) to perform the translation (e.g., page table walk). In certain embodiments, this feature is available for guest system in virtualization. In certain embodiments, the performance benefit is greater by avoiding a nested translation in data path pipeline. Embodiments herein reduce or eliminate delay of both I/O memory controller (e.g., IOMMU) translation and associated (e.g., ATS) communications from the DMA operation, especially useful in virtualization where nested translation is used. Embodiments herein improve performance of I/O memory controller (e.g., IOMMU) by removing latency as discussed herein. In certain embodiments, an I/O (e.g., PCI) device is a network adapter, graphic card, or data accelerator.

FIG. 3 illustrates at 300 a “push translation into a device TLB” (PUSHDTLB) instruction that causes a translation pipeline flow in parallel with a data path pipeline flow with a device TLB hit according to embodiments of the disclosure. Flow 300 includes, at 302, an application (e.g., software) preparing user space buffer(s), e.g., to be accessed by a device via DMA and calling a PUSHDTLB) instruction that provides the virtual address of the buffer. Flow 300 includes, at 304, application (e.g., via execution of the application's instruction(s) on a processor core) writing MIMO register(s) of device (e.g., MIMO register(s) 114 of I/O device 112 in FIG. 1) to notify an I/O job. Flow 300 includes, at 306 (e.g., in parallel with or before 304), the processor informing the I/O memory controller (e.g., IOMMU) to pre-translate the virtual address (e.g., before a miss) and fill the device's TLB with that translation. Flow 300 includes, at 308, that virtual address being looked up and hitting in the device TLB, e.g., where the latency shown in FIG. 2 while waiting for the page walk and the (e.g., PCIe) messages to be sent/processed is now removed. Flow 300 includes, at 310, the device sending a DMA request with the translated address (e.g., physical address) to be serviced (e.g., sending the request to the I/O memory controller (e.g., IOMMU)). Flow 300 includes, at 312, the I/O memory controller (e.g., IOMMU)) accessing the memory with the translated address (e.g., the corresponding physical address from the address translation).

In certain embodiments, the parallel translation pipeline completes faster than the (e.g., PCI) device receives a corresponding request for a DMA operation (e.g., where the PCI MMIO link is slower than the local memory controller). So, when the (e.g., PCI) device receives the request for a DIA job, the translation result is already present in the device TLB in certain embodiments. Therefore, the (e.g., PCI) device can send a DMA request with the translated address directly and avoid the step of requesting the I/O memory controller (e.g., IOMMU) to perform address translation in the data path pipeline in certain embodiments.

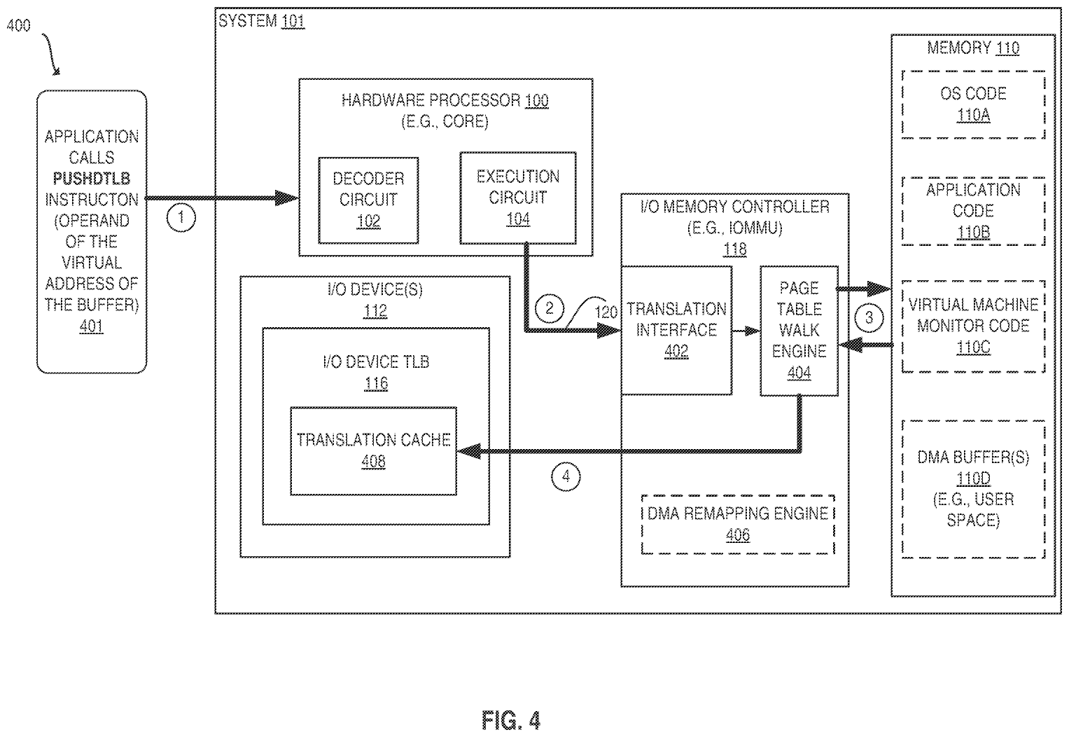

FIG. 4 illustrates a translation pipeline flow 400 in a computer system 101 including a hardware processor 100 and an input/output (I/O) device 112 coupled to an I/O memory controller 118 according to embodiments of the disclosure. Depicted I/O memory controller 118 includes a translation interface 402 to receive commands from the hardware processor core, e.g., a command to cause a page table walk by page table walk engine 404 and a corresponding fill of the translation (e.g., PA) into device TLB (e.g., translation cache 408 thereof).

Depicted flow 400 includes an (e.g., asynchronous translation pipeline (circles 1 to 4) performing the following: at circle 1: software calling a PUSHDTLB instruction 401 and providing a virtual address as operand (e.g., as well as device ID for I/O device 112). In certain embodiments, the hardware processor 100 (e.g., central processing unit (CPU)) decodes the instruction with the decoder circuit 102 and executes the decoded instruction with the execution circuit 104 to cause the launch of an asynchronous job, e.g., while the instruction returns immediately so that the application continues interacting with (e.g., MMIO register(s) 114 in FIG. 1) of the I/O (e.g., PCI) device 112 without causing delay. At circle 2, in certain embodiments the processor (e.g., CPU) extracts the PASID from the process context, e.g., via a register 106 in FIG. 1 (e.g., IA32_PASID MSR). At circle 2, in certain embodiments the processor (e.g., CPU) sends the request to I/O memory controller (e.g., IOMMU) via translation interface 402 (e.g., register or internal channel), e.g., providing PASID and VA as parameters.

At circle 3, in certain embodiments the I/O memory controller (e.g., IOMMU) 118 locates PASID context of the devices and using the PASID locates the physical address of first level and/or second level page table (e.g., depending on the PASID Granular Translation Type (PGTT) setting of the PASID context). At circle 3, in certain embodiments the I/O memory controller (e.g., IOMMU) 118 performs translation for the VA to acquire the PA. In certain embodiments, the I/O memory controller (e.g., IOMMU) 118 may look up from IOTLB (e.g., IOTLB 126 in FIG. 1) if this VA is already translated to avoid redundant translation for the same buffer. In certain embodiments, if secure ATS data structure 122 and circuitry are supported by I/O memory controller (e.g., IOMMU), the secure ATS circuitry will add an entry in the secure ATS data structure (e.g., table) 122 to allow the corresponding PCI device to access the translated physical address. At circle 4, in certain embodiments the I/O memory controller (e.g., IOMMU) 118 sends a “Push TLB PCI message” (e.g., posted transaction) to the corresponding PCI device(s). In certain embodiments, the VA, PA, and/or PASID are contained in the message. In certain embodiments, the I/O (e.g., PCI) device updates the device TLB 116 (e.g., translation cache 408), e.g., and creates translation cache 408 accordingly if the translation does not exist.

In certain embodiments, I/O memory controller 118 includes a DMA remapping engine 406. In certain embodiments, DMA remapping engine 406 provides hardware support for isolation of device accesses to memory, and enables each device in the system to be assigned to a specific domain through a distinct set of paging structures. When the device attempts to access system memory, in certain embodiments, the DMA remapping engine 406 (e.g., hardware) intercepts the access and utilizes the page tables to determine whether the access can be permitted. In certain embodiments, the DMA remapping engine 406 determines the actual location to access. Frequently used paging structures can be cached in hardware. DMA remapping can be configured independently for each device, or collectively across multiple devices.

Examples of ways in which operating systems can use DMA remapping are: (i) OS protection: an OS may define a domain containing its critical code and data structures, and restrict access to this domain from all I/O devices in the system, e.g., where this allows the OS to limit erroneous or unintended corruption of its data and code through incorrect programming of devices by device drivers, thereby improving OS robustness and reliability, (ii) feature support: an OS may use domains to better manage DMA from legacy devices to high memory (for example, 32-bit PCI devices accessing memory above 4 GB), e.g., this is achieved by programming the I/O page-tables to remap DMA from these devices to high memory and without such support, software is to resort to data copying through OS “bounce buffers”, (iii) DMA isolation: an OS may manage i/o by creating multiple domains and assigning one or more I/O devices to each domain. each device-driver explicitly registers its i/o buffers with the OS, and the OS assigns these I/O buffers to specific domains, using hardware to enforce DMA domain protection, and/or (iv) shared virtual memory: for devices supporting appropriate (e.g., PCIe) capabilities, OS may use the DMA remapping hardware capabilities to share virtual address space of application processes with I/O devices, e.g., where shared virtual memory along with support for I/O page-faults enable application programs to freely pass arbitrary data-structures to devices such as, but not limited to graphics processors or accelerators, without the overheads of pinning and marshalling of data.

Examples of ways in which a virtual machine monitor can use DMA remapping are the driver for an assigned I/O device runs only in the partition to which it is assigned and is allowed to interact directly with the device hardware with minimal or no VMM involvement, e.g., where the DMA remapping engine 406 enables this direct device assignment without device-specific knowledge in the VMM. In this model, the VMM restricts itself to enabling direct assignment of devices to their partitions. Rather than invoking the VMM for all I/O requests from a partition, the VMM is invoked only when guest software accesses protected resources (such as configuration accesses, interrupt management, etc.) that impact system functionality and isolation in certain embodiments. To support direct assignment of I/O devices, a VMM must enforce isolation of DMA requests in certain embodiments. In certain embodiments, I/O devices can be assigned to domains, and the DMA remapping engine 406 used to restrict DMA from an I/O device to the physical memory presently owned by its domain. For domains that may be relocated in physical memory, the DMA remapping engine 406 is programmed to perform the necessary translation in certain embodiments. I/O device assignment allows other I/O sharing usages for example, assigning an I/O device to an I/O partition that provides I/O services to other user partitions. In certain embodiments, DMA remapping engine 406 enables virtualization software to choose the right combination of device assignment and software-based methods for I/O virtualization.

Examples of ways in which a guest virtual machine can use DMA remapping are the virtual machine monitor (VMM) may virtualize the DMA remapping engine 406 to its guests, for example, the VMM may intercept guest accesses to the virtual remapping hardware registers, and manage a shadow copy of the guest remapping structures that is provided to the physical remapping hardware, e.g., on updates to the guest I/O page tables, the guest software performs appropriate virtual invalidation operations. The virtual invalidation requests may be intercepted by the VMM, to update the respective shadow page tables and perform invalidations of the DMA remapping engine 406. In certain embodiments, due to the non-restartability of faulting DMA transactions (e.g., unlike CPU memory management virtualization), a VMM cannot perform lazy updates to its shadow remapping structures, e.g., to keep the shadow structures consistent with the guest structures, the VMM may expose virtual remapping hardware with eager pre-fetching behavior (including caching of not-present entries) or use processor memory management mechanisms to write-protect the guest remapping structures. On hardware implementations supporting two levels of address translations (first-level translation to remap a virtual address to intermediate (guest) physical address, and second-level translations to remap an intermediate physical address to machine (host) physical address), a VNN may virtualize guest OS use of first-level translations without shadowing page-tables, but by configuring hardware to perform nested translation of first and second levels.

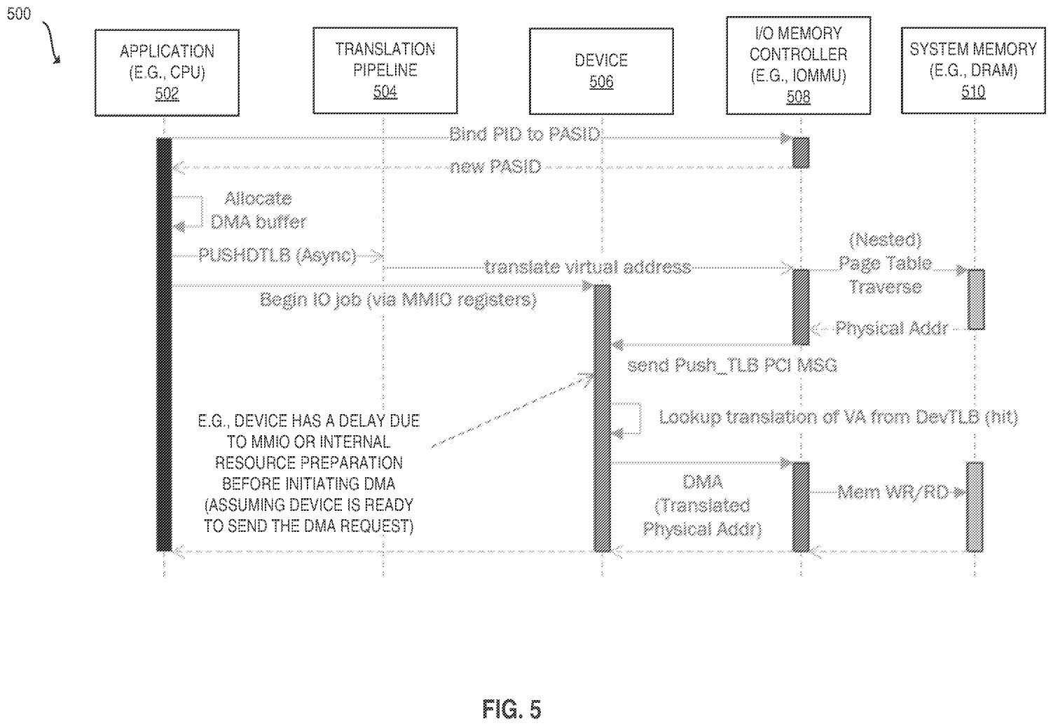

FIG. 5 is a swimlane diagram illustrating operations 500 of a method of using a PUSHDTLB instruction according to embodiments of the disclosure. Depicted operations 500 include application (e.g., as executed by CPU) 502 binding a posted interrupt descriptor (PID) to a PASID, e.g., and for a new PASID, the I/O memory controller (e.g., IOMMU) 508 sending a new PASID to application 502. Depicted operations 500 include application 502 allocating a DMA buffer, e.g., for the device 506. Depicted operations 500 include application 502 requesting execution of a PUSHDTLB instruction, e.g., to translation pipeline 504 (e.g., circles 2 to 4 in FIG. 4). Depicted operations 500 include translation pipeline 504 sending a request to I/O memory controller (e.g., IOMMU) 508 to perform a page table walk. Depicted operations 500 include I/O memory controller (e.g., IOMMU) 508 to requesting a page table walk of the system memory 510 (e.g., dynamic random-access memory (DRAM)) for the physical address. Depicted operations 500 include system memory 510 sending the physical address to I/O memory controller (e.g., IOMMU) 508. Depicted operations 500 include I/O memory controller (e.g., IOMMU) 508 sending a push message to device 506 to cause the device to populate its device TLB with that translation, etc.

Depicted operations 500 include device 506 performing a lookup in its device TLB of the virtual address to be accessed, and the physical address returned as there is a hit in certain embodiments where the device TLB was pre-populated. Depicted operations 500 include device 506 sending a direct memory access (DMA) request that identifies this physical address to I/O memory controller (e.g., IOMMU) 508 and the I/O memory controller (e.g., IOMMU) 508 performing the access (e.g., read and/or write) accordingly in system memory 510.

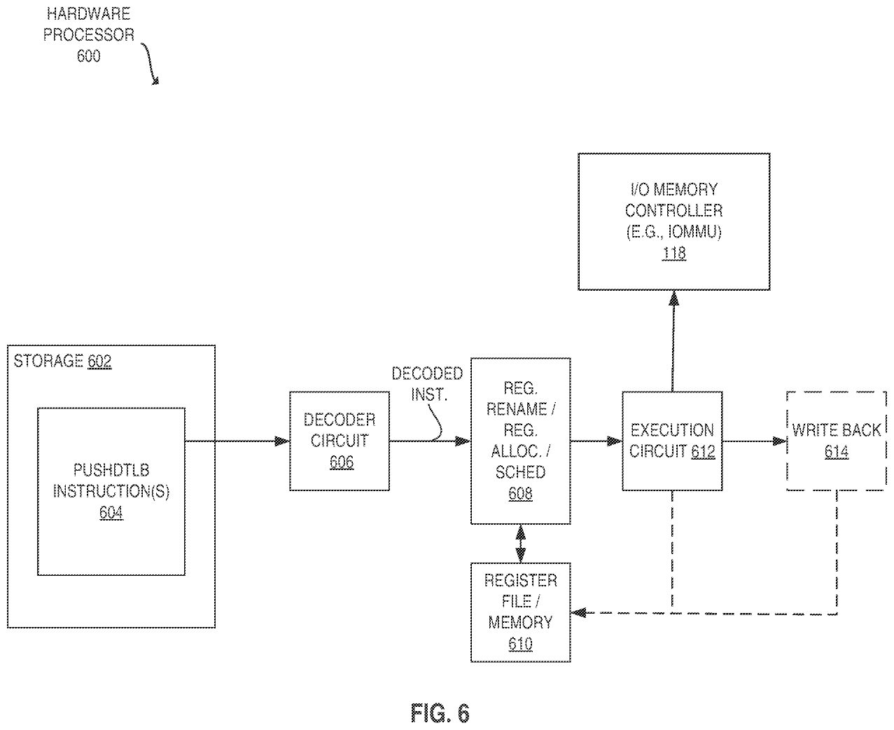

FIG. 6 illustrates a hardware processor 600 coupled to storage 602 that includes one or more PUSHDTLB instructions 604 according to embodiments of the disclosure.

In certain embodiments, a PUSHDTLB instruction is according to any of the disclosure herein. In one embodiment, e.g., in response to a request to perform an operation, the instruction (e.g., macro-instruction) is fetched from storage 602 and sent to decoder circuit 606. In the depicted embodiment, the decoder circuit 606 (e.g., decoder circuit) decodes the instruction into a decoded instruction (e.g., one or more micro-instructions or micro-operations). The decoded instruction is then sent for execution, e.g., via scheduler circuit 608 to schedule the decoded instruction for execution.

In certain embodiments, (e.g., where the processor/core supports out-of-order (OoO) execution), the processor includes a register rename/allocator circuit coupled to register file/memory circuit 610 (e.g., unit) to allocate resources and perform register renaming on registers (e.g., vector registers associated with a logical operation and test instruction). In certain embodiments, (e.g., for out-of-order execution), the processor includes one or more scheduler circuits 608 coupled to the decoder. The scheduler circuit(s) may schedule one or more operations associated with decoded instructions, including one or more operations decoded from a PUSHDTLB instruction, for execution on the execution circuit 612. In certain embodiments, execution circuit 612 sends a job descriptor to I/O memory controller (e.g., IOMMU) 118 for it to perform operations, e.g., as discussed herein.

In certain embodiments, a write back circuit 614 is included to write back results of an instruction to a destination (e.g., write them to a register(s) and/or memory), for example, so those results are visible within a processor (e.g., visible outside of the execution circuit that produced those results).

One or more of these components (e.g., decoder circuit 606, register rename/register allocator/scheduler 608, execution circuit 612, register file/memory 610, or write back circuit 614) may be in a single core of a hardware processor (e.g., and multiple cores each with an instance of these components.

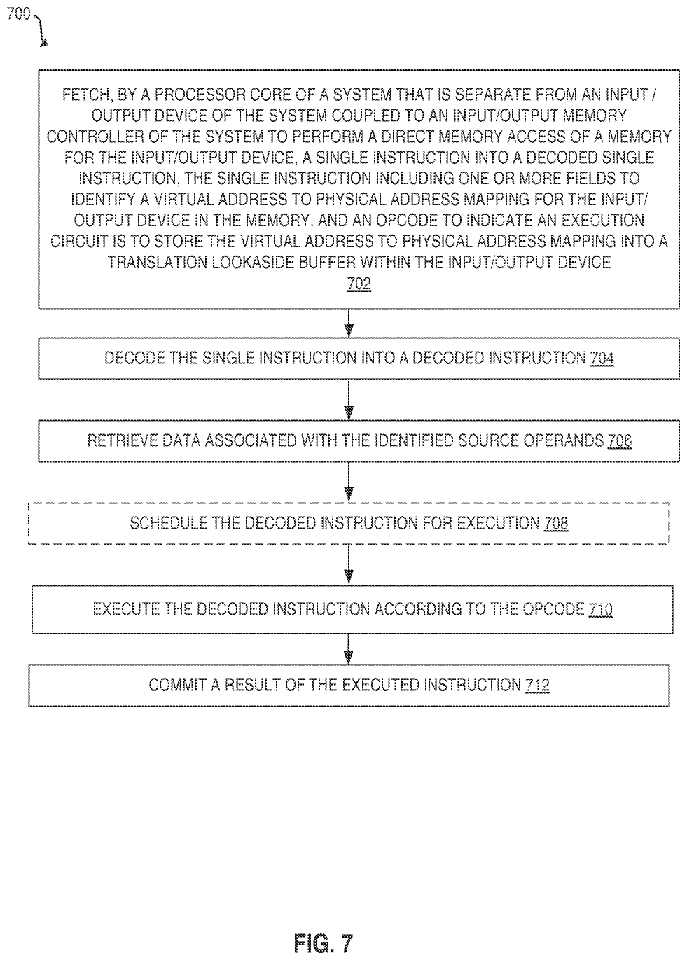

FIG. 7 illustrates a method 700 of processing a PUSHDTLB instruction according to embodiments of the disclosure. A processor (e.g., or processor core) may perform method 700, e.g., in response to receiving a request to execute an instruction from software. Depicted method 700 includes processing a PUSHDTLB instruction by: fetch, by a processor core of a system that is separate from an input/output device of the system coupled to an input/output memory controller of the system to perform a direct memory access of a memory for the input/output device, a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device at 702, decode the single instruction into a decoded instruction at 704, retrieve data associated with the identified source operands at 706, (optionally) schedule the decoded instruction for execution at 708, execute the decoded instruction according to the opcode at 710, and commit a result of the executed instruction at 712.

In certain embodiments, a PUSHDTLB instruction is only available in a processor (e.g., CPU) that supports Scalable Mode IOMMU and shared virtual memory (SVM). In certain embodiments, the PUSHTLB instruction can only be used with (e.g., PCI) device(s) that support a “Push TLB (e.g., PCI) Message”. In certain embodiments, a user space driver is to query for device capability before using the PUSHTLB instruction, e.g., and if PUSHTLB is requested on devices not supporting this feature, the device will respond with an “unsupported request” indication after receiving the Push TLB (e.g., PCI) message and/or IOMMU is to raise an exception upon detecting such event. In certain embodiments, a PUSHDTLB instruction works in asynchronous mode. In certain embodiments, the PASID is not visible to an application but is preserved in a (e.g., IA32_PASID) register. In certain embodiments, the PASID is retrieved by the processor automatically after executing the PUSHDTLB instruction, e.g., to prevent malicious attempts. In certain embodiments, an application calls the PUSHDTLB instruction explicitly to utilize this feature. In certain embodiments, it is not mandatory that a device driver uses a PUSHDTLB instruction to warm up a device TLB. In certain embodiments, an application recursively calls PUSHDTLB instruction if multiple buffers are to be accessed by the (e.g., PCI) device through DMA (e.g., source buffer, destination buffer, scattered buffer list, etc.). In certain embodiments, a translation pipeline (e.g., in I/O memory controller (e.g., IOMMU)) holds translation requests in a (e.g., first-in, first out (FIFO) buffer) and processes them sequentially. In certain embodiments, malicious attempt to abuse this instruction are detected by the processor, e.g., and an exception is raised to supervisor software (e.g., kernel or hypervisor) so that the malicious application can be terminated immediately.

In certain embodiments, a device TLB is a translation cache at the endpoint device (e.g., as opposed to in the platform). In certain embodiments, the Process Address Space Identifier is a value that identifies the address space targeted by DMA requests, e.g., for requests with PASID, the PASID value is provided in the PASID Transaction Layer Packet (TLP) prefix of the request and/or for requests without PASID, the PASID value is programmed in a scalable-mode context-entry used to process the request.

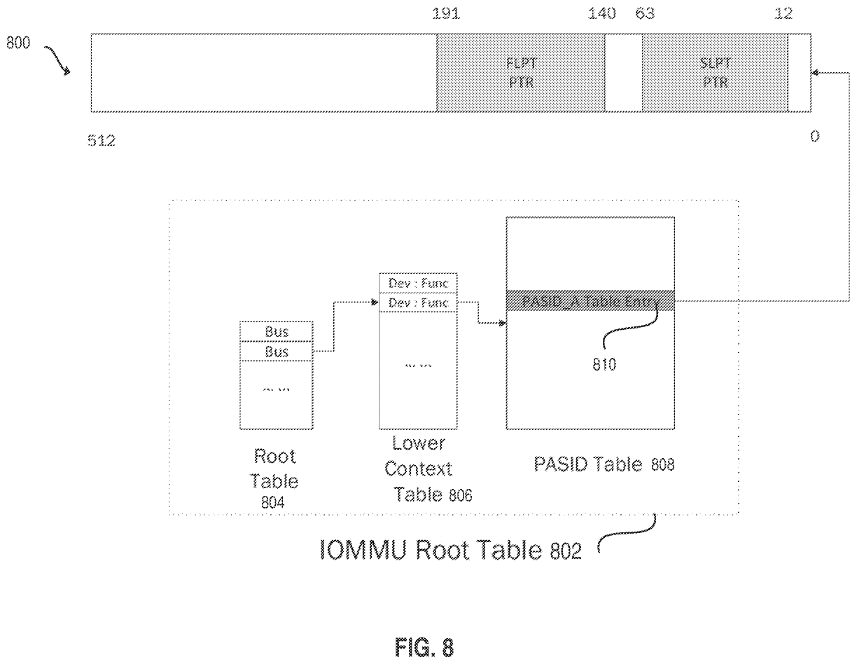

FIG. 8 illustrates an I/O memory controller (e.g., an input/output memory management unit (IOMMU)) process address space identifier (PASID) mapping structure (e.g., root table 802) according to embodiments of the disclosure. Depicted root table 804 includes a bus entry that points to an entry for a device (e.g., function) in lower context table 806 that points to an entry 810 in PASID table 808 that points to a value 800 that includes a first level page table (FLPT) pointer and a second level page table (SLPT) pointer.

In certain embodiments, each inbound request appearing at the address-translation hardware (e.g., I/O memory controller 118 or 508) is required to identify the device originating the request. The (e.g., 16 bit) attribute identifying the originator of an I/O transaction may be referred to as the source ID.

In certain embodiments, remapping hardware (e.g., DMA remapping engine 406) is to determine the source ID of a transaction in implementation-specific ways. For example, some I/O bus protocols may provide the originating device identity as part of each I/O transaction. In other cases (e.g., for Root-Complex integrated devices, for example), the source ID may be derived based on the Root-Complex internal implementation. For PCI Express devices, the source ID is the requester identifier in the PCI Express transaction layer header in certain embodiments, e.g., where the requester identifier of a device, which is composed of its PCI Bus number/Device number/Function number, is assigned by configuration software and uniquely identifies the hardware function that initiated the request.

FIG. 9 illustrates a requester identifier format 900 and a device to domain mapping structure in scalable mode according to embodiments of the disclosure. Requester identifier format 900 includes a (e.g., PCI) bus number, device number, and function number. FIG. 9 illustrates device to domain mapping with scalable-mode context-table at 902.

For example: for implementations supporting Scalable Mode Translation (SMTS=1 in Extended Capability Register), the Root Table Address Register (RTADDR_REG) points to a scalable-mode root-table when the Translation Table Mode field in the RTADDR_REG register is programmed to scalable-mode (RTADDR_REG.TTM is 01b). The scalable-mode root-table is similar to the root-table (e.g., 4 KB in size and containing 256 scalable-mode root-entries to cover the 0-255 PCI bus number space), but has a different format to reference scalable-mode context-entries. Each scalable-mode root-entry references a lower scalable-mode context-table and an upper scalable-mode context-table. The lower scalable-mode context-table is 4-KByte in size and contains 128 scalable-mode context entries corresponding to PCI functions in device range 0-15 on the bus. The upper scalable-mode context-table is also 4-KByte in size and contains 128 scalable-mode context-entries corresponding to PCI functions in device range 16-31 on the bus. Scalable-mode context-entries support both requests-without-PASID and requests-with-PASID. However, unlike legacy mode, in scalable-mode, requests-without-PASID obtain a PASID value from the RID_PASID field of the scalable-mode context entry and are processed similarly to requests-with-PASID. Implementations not supporting RID_PASID capability (ECAP_REG.RPS is Ob), use a PASID value of 0 to perform address translation for requests without PASID. The scalable-mode context-entry contains a pointer to a scalable-mode PASID directory. The upper 14 bits (bits 19:6) of the request's PASID value are used to index into the scalable-mode PASID directory. Each present scalable-mode PASID directory entry contains a pointer to a scalable-mode PASID-table. The lower 6 bits (bits 5:0) of the request's PASID value are used to index into the scalable-mode PASID-table. The PASID-table entries contain pointers to both first-level and second-level translation structures, along with PASID Granular Translation Type (PGTT) field which specifies whether the request undergoes a first-level, second-level, nested, or pass-through translation process. The above numbers are merely examples and it should be understood that any other values are possible.

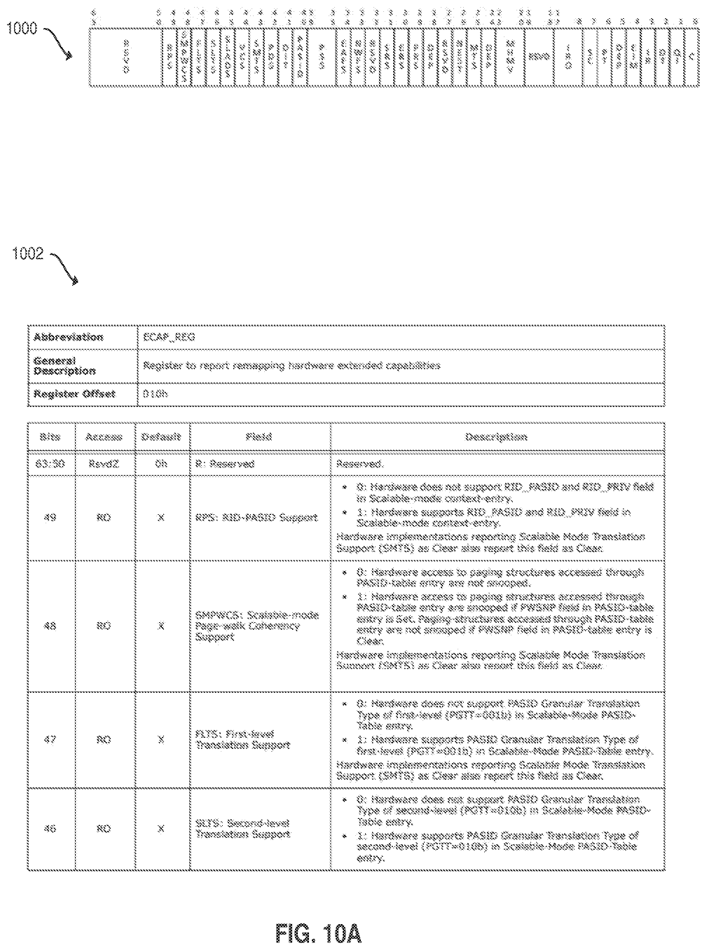

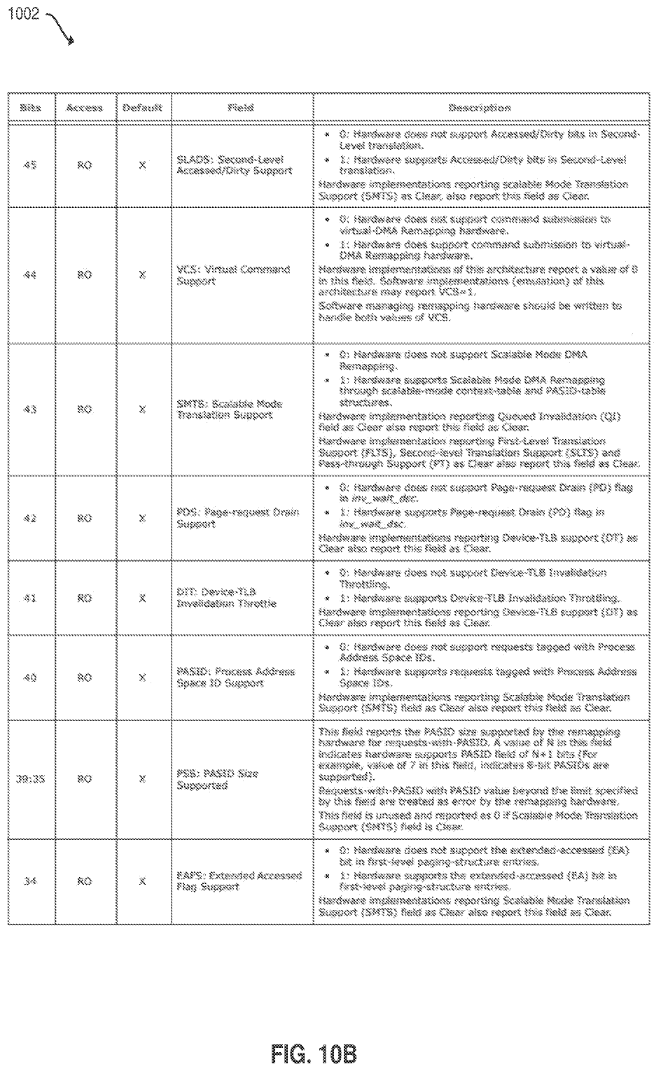

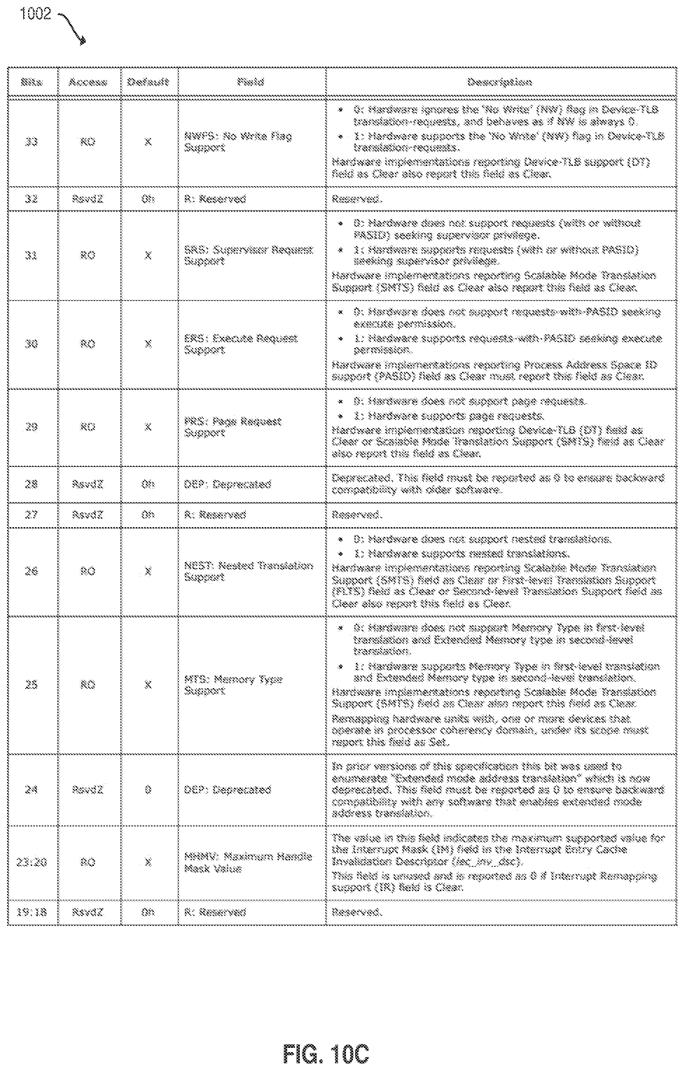

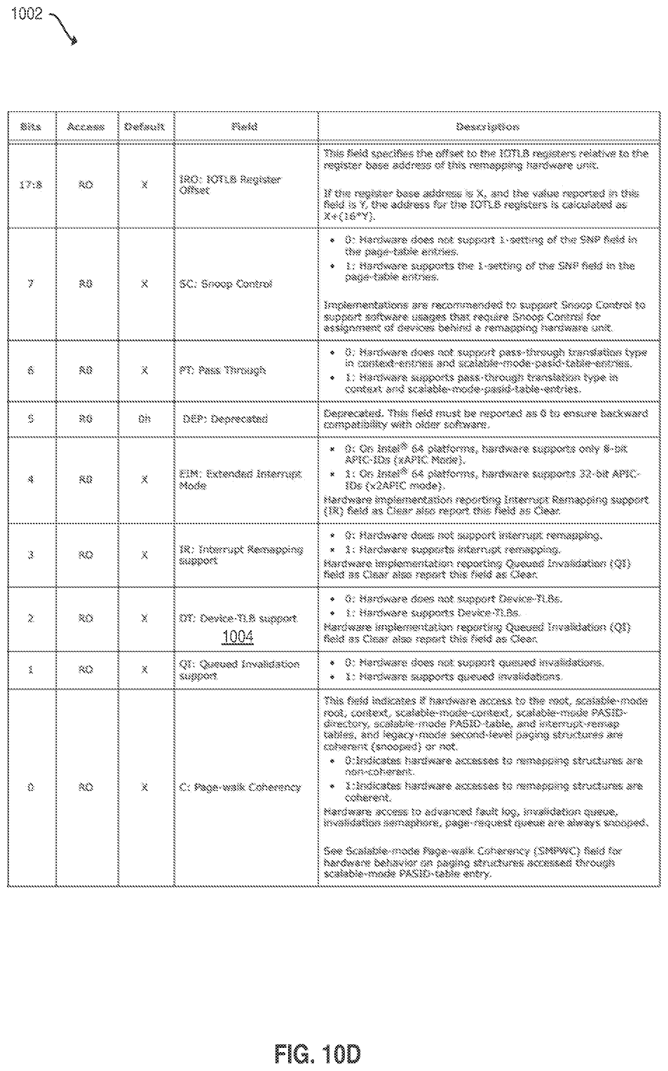

FIGS. 10A-10D illustrate a format 1000 of an extended capability register and example descriptions 1002 of the fields including a device TLB (“DT”) support field 1004 (in FIG. 8D) according to embodiments of the disclosure. In certain embodiments, an instruction executes on a processor and returns the capabilities according to the format 1000 of the extended capability register, e.g., where bit [2] set to 1 indicates the hardware (e.g., device) supports device TLBs.

Exemplary architectures, systems, etc. that the above may be used in are detailed below. Exemplary instruction formats for the instructions disclosed herein are detailed below.

At least some embodiments of the disclosed technologies can be described in view of the following examples:
Example 1. An apparatus comprising:
   an input/output memory controller to perform a direct memory access of a memory for an input/output device separate from a processor core; and
   the processor core comprising:
      a decoder circuit to decode a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device, and
      the execution circuit to execute the decoded single instruction according to the opcode.
Example 2. The apparatus of example 1, wherein the opcode is to indicate the execution circuit is to cause the input/output memory controller to send a message to the input/output device that identifies the virtual address to physical address mapping.
Example 3. The apparatus of example 2, wherein the message further comprises a process address space identifier.
Example 4. The apparatus of example 3, wherein the opcode is to indicate the execution circuit is to determine the process address space identifier from a process address space identifier register of the processor core.
Example 5. The apparatus of example 1, wherein the one or more fields are to identify a device identification value of the input/output device.
Example 6. The apparatus of example 1, wherein the opcode is to indicate the execution circuit is to cause the input/output memory controller to perform a page walk of the memory to determine the virtual address to physical address mapping.
Example 7. The apparatus of example 6, wherein the input/output device comprises a register, that when written with a value by execution of the single instruction, causes the input/output memory controller to perform the page walk.
Example 8. The apparatus of example 1, wherein the opcode is to indicate the execution circuit is to cause the input/output memory controller to add an entry into a secure address translation service data structure of the input/output memory controller that indicates the input/output device is allowed to access the physical address in the memory.
Example 9. A method comprising:
   decoding, by a processor core of a system that is separate from an input/output device of the system coupled to an input/output memory controller of the system to perform a direct memory access of a memory for the input/output device, a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device; and
   executing the decoded single instruction by the execution circuit according to the opcode.
Example 10. The method of example 9, wherein the opcode is to indicate the execution circuit is to cause the input/output memory controller to send a message to the input/output device that identifies the virtual address to physical address mapping.
Example 11. The method of example 10, wherein the message further comprises a process address space identifier.
Example 12. The method of example 11, wherein the opcode is to indicate the execution circuit is to determine the process address space identifier from a process address space identifier register of the processor core.
Example 13. The method of example 9, wherein the one or more fields are to identify a device identification value of the input/output device.
Example 14. The method of example 9, wherein the opcode is to indicate the execution circuit is to cause the input/output memory controller to perform a page walk of the memory to determine the virtual address to physical address mapping.
Example 15. The method of example 14, wherein the input/output device comprises a register, that when written with a value by the executing of the single instruction, causes the input/output memory controller to perform the page walk.
Example 16. The method of example 9, wherein the opcode is to indicate the execution circuit is to cause the input/output memory controller to add an entry into a secure address translation service data structure of the input/output memory controller that indicates the input/output device is allowed to access the physical address in the memory.
Example 17. A system comprising:
   an input/output device;
   an input/output memory controller to perform a direct memory access of a memory for the input/output device; and
   a processor core separate from the input/output device and comprising:
      a decoder circuit to decode a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device, and
      the execution circuit to execute the decoded single instruction according to the opcode.
Example 18. The system of example 17, wherein the opcode is to indicate the execution circuit is to cause the input/output memory controller to send a message to the input/output device that identifies the virtual address to physical address mapping.
Example 19. The system of example 18, wherein the message further comprises a process address space identifier.
Example 20. The system of example 19, wherein the opcode is to indicate the execution circuit is to determine the process address space identifier from a process address space identifier register of the processor core.
Example 21. The system of example 17, wherein the one or more fields are to identify a device identification value of the input/output device.
Example 22. The system of example 17, wherein the opcode is to indicate the execution circuit is to cause the input/output memory controller to perform a page walk of the memory to determine the virtual address to physical address mapping.
Example 23. The system of example 22, wherein the input/output device comprises a register, that when written with a value by execution of the single instruction, causes the input/output memory controller to perform the page walk.
Example 24. The system of example 17, wherein the opcode is to indicate the execution circuit is to cause the input/output memory controller to add an entry into a secure address translation service data structure of the input/output memory controller that indicates the input/output device is allowed to access the physical address in the memory.

In yet another embodiment, an apparatus comprises a data storage device that stores code that when executed by a hardware processor causes the hardware processor to perform any method disclosed herein. An apparatus may be as described in the detailed description. A method may be as described in the detailed description.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, November 2018; and see Intel® Architecture Instruction Set Extensions Programming Reference, October 2018).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

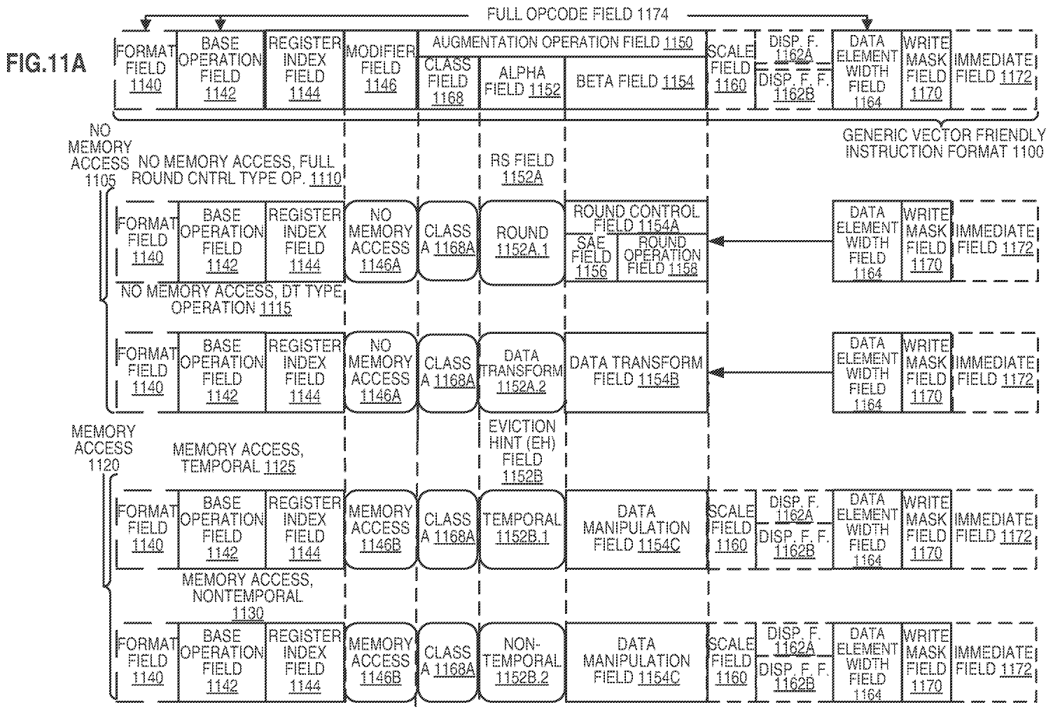

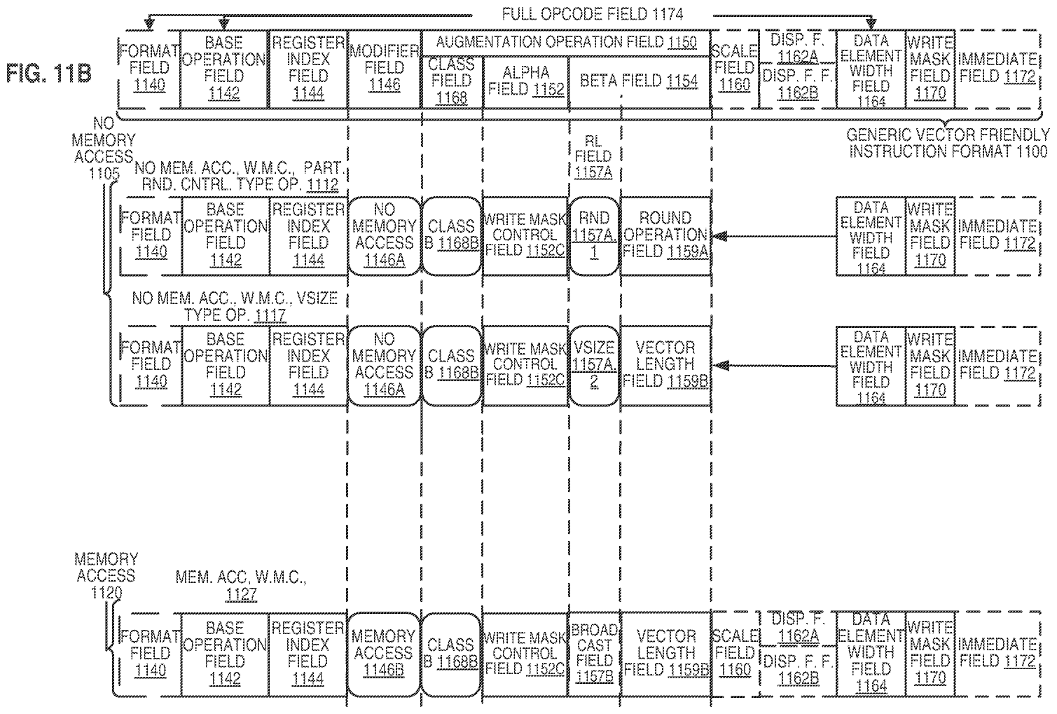

FIGS. 11A-11B are block diagrams illustrating a generic vector friendly instruction format and instruction templates thereof according to embodiments of the disclosure. FIG. 11A is a block diagram illustrating a generic vector friendly instruction format and class A instruction templates thereof according to embodiments of the disclosure; while FIG. 11B is a block diagram illustrating the generic vector friendly instruction format and class B instruction templates thereof according to embodiments of the disclosure. Specifically, a generic vector friendly instruction format 1100 for which are defined class A and class B instruction templates, both of which include no memory access 1105 instruction templates and memory access 1120 instruction templates. The term generic in the context of the vector friendly instruction format refers to the instruction format not being tied to any specific instruction set.

While embodiments of the disclosure will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 11A include: 1) within the no memory access 1105 instruction templates there is shown a no memory access, full round control type operation 1110 instruction template and a no memory access, data transform type operation 1115 instruction template; and 2) within the memory access 1120 instruction templates there is shown a memory access, temporal 1125 instruction template and a memory access, non-temporal 1130 instruction template. The class B instruction templates in FIG. 11B include: 1) within the no memory access 1105 instruction templates there is shown a no memory access, write mask control, partial round control type operation 1112 instruction template and a no memory access, write mask control, vsize type operation 1117 instruction template; and 2) within the memory access 1120 instruction templates there is shown a memory access, write mask control 1127 instruction template.

The generic vector friendly instruction format 1100 includes the following fields listed below in the order illustrated in FIGS. 11A-11B.

Format field 1140—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1142—its content distinguishes different base operations.

Register index field 1144—its content, directly or through address generation, specifies the locations of the source and destination operands, be they in registers or in memory. These include a sufficient number of bits to select N registers from a PxQ (e.g., 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 1146—its content distinguishes occurrences of instructions in the generic vector instruction format that specify memory access from those that do not; that is, between no memory access 1105 instruction templates and memory access 1120 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 1150—its content distinguishes which one of a variety of different operations to be performed in addition to the base operation. This field is context specific. In one embodiment of the disclosure, this field is divided into a class field 1168, an alpha field 1152, and a beta field 1154. The augmentation operation field 1150 allows common groups of operations to be performed in a single instruction rather than 2, 3, or 4 instructions.

Scale field 1160—its content allows for the scaling of the index field's content for memory address generation (e.g., for address generation that uses 2^{scale}*index+base).

Displacement Field 1162A—its content is used as part of memory address generation (e.g., for address generation that uses 2^{scale}*index+base+displacement).

Displacement Factor Field 1162B (note that the juxtaposition of displacement field 1162A directly over displacement factor field 1162B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1174 (described later herein) and the data manipulation field 1154C. The displacement field 1162A and the displacement factor field 1162B are optional in the sense that they are not used for the no memory access 1105 instruction templates and/or different embodiments may implement only one or none of the two.

Data element width field 1164—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1170—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1170 allows for partial vector operations, including loads, stores, arithmetic, logical, etc. While embodiments of the disclosure are described in which the write mask field's 1170 content selects one of a number of write mask registers that contains the write mask to be used (and thus the write mask field's 1170 content indirectly identifies that masking to be performed), alternative embodiments instead or additional allow the mask write field's 1170 content to directly specify the masking to be performed.

Immediate field 1172—its content allows for the specification of an immediate. This field is optional in the sense that is it not present in an implementation of the generic vector friendly format that does not support immediate and it is not present in instructions that do not use an immediate.

Class field 1168—its content distinguishes between different classes of instructions. With reference to FIGS. 11A-B, the contents of this field select between class A and class B instructions. In FIGS. 11A-B, rounded corner squares are used to indicate a specific value is present in a field (e.g., class A 1168A and class B 1168B for the class field 1168 respectively in FIGS. 11A-B).

### Instruction Templates of Class A

In the case of the non-memory access 1105 instruction templates of class A, the alpha field 1152 is interpreted as an RS field 1152A, whose content distinguishes which one of the different augmentation operation types are to be performed (e.g., round 1152A.1 and data transform 1152A.2 are respectively specified for the no memory access, round type operation 1110 and the no memory access, data transform type operation 1115 instruction templates), while the beta field 1154 distinguishes which of the operations of the specified type is to be performed. In the no memory access 1105 instruction templates, the scale field 1160, the displacement field 1162A, and the displacement scale filed 1162B are not present.

### No-Memory Access Instruction Templates—Full Round Control Type Operation

In the no memory access full round control type operation 1110 instruction template, the beta field 1154 is interpreted as a round control field 1154A, whose content(s) provide static rounding. While in the described embodiments of the disclosure the round control field 1154A includes a suppress all floating-point exceptions (SAE) field 1156 and a round operation control field 1158, alternative embodiments may support may encode both these concepts into the same field or only have one or the other of these concepts/fields (e.g., may have only the round operation control field 1158).

SAE field 1156—its content distinguishes whether or not to disable the exception event reporting; when the SAE field's 1156 content indicates suppression is enabled, a given instruction does not report any kind of floating-point exception flag and does not raise any floating-point exception handler.

Round operation control field 1158—its content distinguishes which one of a group of rounding operations to perform (e.g., Round-up, Round-down, Round-towards-zero and Round-to-nearest). Thus, the round operation control field 1158 allows for the changing of the rounding mode on a per instruction basis. In one embodiment of the disclosure where a processor includes a control register for specifying rounding modes, the round operation control field's 1150 content overrides that register value.

### No Memory Access Instruction Templates—Data Transform Type Operation

In the no memory access data transform type operation 1115 instruction template, the beta field 1154 is interpreted as a data transform field 1154B, whose content distinguishes which one of a number of data transforms is to be performed (e.g., no data transform, swizzle, broadcast).

In the case of a memory access 1120 instruction template of class A, the alpha field 1152 is interpreted as an eviction hint field 1152B, whose content distinguishes which one of the eviction hints is to be used (in FIG. 11A, temporal 1152B.1 and non-temporal 1152B.2 are respectively specified for the memory access, temporal 1125 instruction template and the memory access, non-temporal 1130 instruction template), while the beta field 1154 is interpreted as a data manipulation field 1154C, whose content distinguishes which one of a number of data manipulation operations (also known as primitives) is to be performed (e.g., no manipulation; broadcast; up conversion of a source; and down conversion of a destination). The memory access 1120 instruction templates include the scale field 1160, and optionally the displacement field 1162A or the displacement scale field 1162B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely. Instruction Templates of Class B

In the case of the instruction templates of class B, the alpha field 1152 is interpreted as a write mask control (Z) field 1152C, whose content distinguishes whether the write masking controlled by the write mask field 1170 should be a merging or a zeroing.

In the case of the non-memory access 1105 instruction templates of class B, part of the beta field 1154 is interpreted as an RL field 1157A, whose content distinguishes which one of the different augmentation operation types are to be performed (e.g., round 1157A.1 and vector length (VSIZE) 1157A.2 are respectively specified for the no memory access, write mask control, partial round control type operation 1112 instruction template and the no memory access, write mask control, VSIZE type operation 1117 instruction template), while the rest of the beta field 1154 distinguishes which of the operations of the specified type is to be performed. In the no memory access 1105 instruction templates, the scale field 1160, the displacement field 1162A, and the displacement scale filed 1162B are not present.

In the no memory access, write mask control, partial round control type operation 1110 instruction template, the rest of the beta field 1154 is interpreted as a round operation field 1159A and exception event reporting is disabled (a given instruction does not report any kind of floating-point exception flag and does not raise any floating-point exception handler).

Round operation control field 1159A—just as round operation control field 1158, its content distinguishes which one of a group of rounding operations to perform (e.g., Round-up, Round-down, Round-towards-zero and Round-to-nearest). Thus, the round operation control field 1159A allows for the changing of the rounding mode on a per instruction basis. In one embodiment of the disclosure where a processor includes a control register for specifying rounding modes, the round operation control field's 1150 content overrides that register value.

In the no memory access, write mask control, VSIZE type operation 1117 instruction template, the rest of the beta field 1154 is interpreted as a vector length field 1159B, whose content distinguishes which one of a number of data vector lengths is to be performed on (e.g., 128, 256, or 512 byte).

In the case of a memory access 1120 instruction template of class B, part of the beta field 1154 is interpreted as a broadcast field 1157B, whose content distinguishes whether or not the broadcast type data manipulation operation is to be performed, while the rest of the beta field 1154 is interpreted the vector length field 1159B. The memory access 1120 instruction templates include the scale field 1160, and optionally the displacement field 1162A or the displacement scale field 1162B.

With regard to the generic vector friendly instruction format 1100, a full opcode field 1174 is shown including the format field 1140, the base operation field 1142, and the data element width field 1164. While one embodiment is shown where the full opcode field 1174 includes all of these fields, the full opcode field 1174 includes less than all of these fields in embodiments that do not support all of them. The full opcode field 1174 provides the operation code (opcode).

The augmentation operation field 1150, the data element width field 1164, and the write mask field 1170 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the disclosure, different processors or different cores within a processor may support only class A, only class B, or both classes. For instance, a high-performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the disclosure). Also, a single processor may include multiple cores, all of which support the same class or in which different cores support different class. For instance, in a processor with separate graphics and general-purpose cores, one of the graphics cores intended primarily for graphics and/or scientific computing may support only class A, while one or more of the general-purpose cores may be high-performance general-purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the disclosure. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

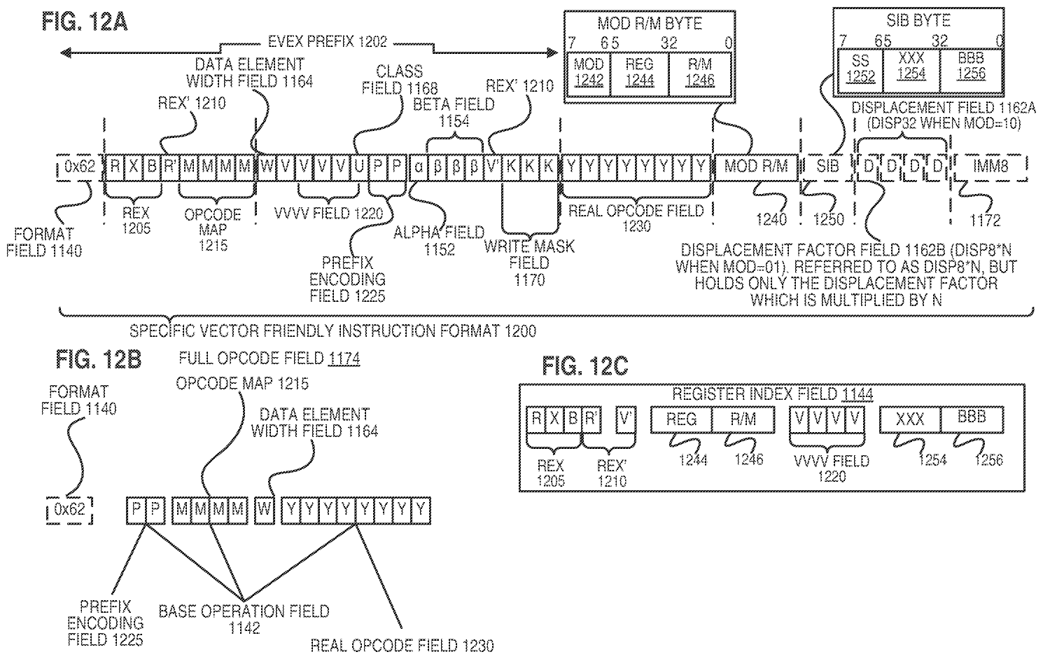

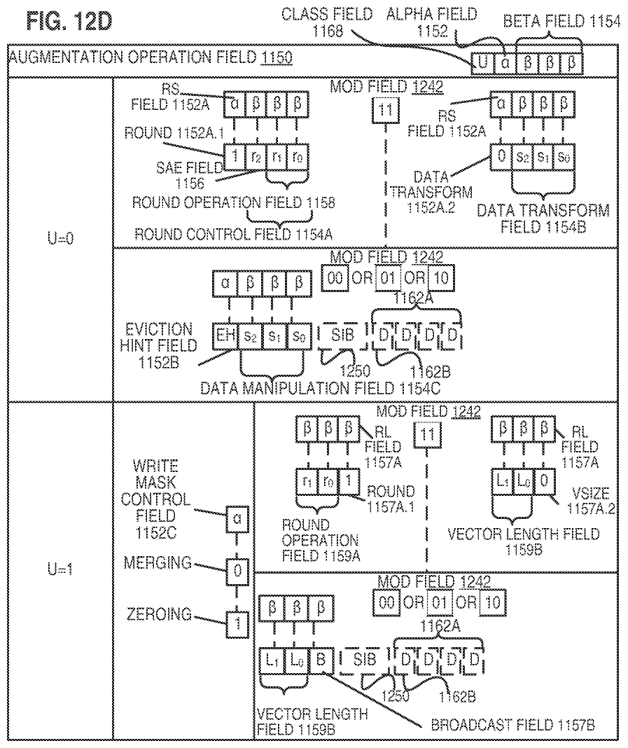

FIG. 12 is a block diagram illustrating an exemplary specific vector friendly instruction format according to embodiments of the disclosure. FIG. 12 shows a specific vector friendly instruction format 1200 that is specific in the sense that it specifies the location, size, interpretation, and order of the fields, as well as values for some of those fields. The specific vector friendly instruction format 1200 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 11 into which the fields from FIG. 12 map are illustrated.

It should be understood that, although embodiments of the disclosure are described with reference to the specific vector friendly instruction format 1200 in the context of the generic vector friendly instruction format 1100 for illustrative purposes, the disclosure is not limited to the specific vector friendly instruction format 1200 except where claimed. For example, the generic vector friendly instruction format 1100 contemplates a variety of possible sizes for the various fields, while the specific vector friendly instruction format 1200 is shown as having fields of specific sizes. By way of specific example, while the data element width field 1164 is illustrated as a one bit field in the specific vector friendly instruction format 1200, the disclosure is not so limited (that is, the generic vector friendly instruction format 1100 contemplates other sizes of the data element width field 1164).

The generic vector friendly instruction format 1100 includes the following fields listed below in the order illustrated in FIG. 12A.

EVEX Prefix (Bytes 0-3) 1202—is encoded in a four-byte form.

Format Field 1140 (EVEX Byte 0, bits [7:0])—the first byte (EVEX Byte 0) is the format field 1140 and it contains 0x62 (the unique value used for distinguishing the vector friendly instruction format in one embodiment of the disclosure).

The second-fourth bytes (EVEX Bytes 1-3) include a number of bit fields providing specific capability.

REX field 1205 (EVEX Byte 1, bits [7-5])—consists of a EVEX.R bit field (EVEX Byte 1, bit [7]—R), EVEX.X bit field (EVEX byte 1, bit [6]—X), and 1157BEX byte 1, bit[5]—B). The EVEX.R, EVEX.X, and EVEX.B bit fields provide the same functionality as the corresponding VEX bit fields, and are encoded using Is complement form, e.g., ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1110—this is the first part of the REX′ field 1110 and is the EVEX.R′ bit field (EVEX Byte 1, bit [4]—R′) that is used to encode either the upper 16 or lower 16 of the extended 32 register set. In one embodiment of the disclosure, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the disclosure do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1215 (EVEX byte 1, bits [3:0]—mmmm)—its content encodes an implied leading opcode byte (0F, 0F 38, or 0F 3).

Data element width field 1164 (EVEX byte 2, bit [7]—W)—is represented by the notation EVEX.W. EVEX.W is used to define the granularity (size) of the datatype (either 32-bit data elements or 64-bit data elements).

EVEX.vvvv 1220 (EVEX Byte 2, bits [6:3]—vvvv)—the role of EVEX.vvvv may include the following: 1) EVEX.vvvv encodes the first source register operand, specified in inverted (Is complement) form and is valid for instructions with 2 or more source operands; 2) EVEX.vvvv encodes the destination register operand, specified in is complement form for certain vector shifts; or 3) EVEX.vvvv does not encode any operand, the field is reserved and should contain 1111b. Thus, EVEX.vvvv field 1220 encodes the 4 low-order bits of the first source register specifier stored in inverted (Is complement) form. Depending on the instruction, an extra different EVEX bit field is used to extend the specifier size to 32 registers. EVEX.U 1168 Class field (EVEX byte 2, bit [2]—U)—If EVEX.U=0, it indicates class A or EVEX.U0; if EVEX.U=1, it indicates class B or EVEXU1.

Prefix encoding field 1225 (EVEX byte 2, bits [1:0]—pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1152 (EVEX byte 3, bit [7]—EH; also known as EVEX.EH, EVEX.rs, EVEX.RL, EVEX.write mask control, and EVEX.N; also illustrated with α)—as previously described, this field is context specific.

Beta field 1154 (EVEX byte 3, bits [6:4]—SSS, also known as EVEX.s₂₋₀, EVEX.r₂₋₀, EVEX.rr1, EVEX.LL0, EVEX.LLB; also illustrated with app)—as previously described, this field is context specific.

REX′ field 1110—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1170 (EVEX byte 3, bits [2:0]—kkk)—its content specifies the index of a register in the write mask registers as previously described. In one embodiment of the disclosure, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1230 (Byte 4) is also known as the opcode byte. Part of the opcode is specified in this field.

MOD R/M Field 1240 (Byte 5) includes MOD field 1242, Reg field 1244, and R/M field 1246. As previously described, the MOD field's 1242 content distinguishes between memory access and non-memory access operations. The role of Reg field 1244 can be summarized to two situations: encoding either the destination register operand or a source register operand, or be treated as an opcode extension and not used to encode any instruction operand. The role of R/M field 1246 may include the following: encoding the instruction operand that references a memory address, or encoding either the destination register operand or a source register operand.

Scale, Index, Base (SIB) Byte (Byte 6)—As previously described, the scale field's 1150 content is used for memory address generation. SIB.xxx 1254 and SIB.bbb 1256—the contents of these fields have been previously referred to with regard to the register indexes Xxxx and Bbbb.

Displacement field 1162A (Bytes 7-10)—when MOD field 1242 contains 10, bytes 7-10 are the displacement field 1162A, and it works the same as the legacy 32-bit displacement (disp32) and works at byte granularity.

Displacement factor field 1162B (Byte 7)—when MOD field 1242 contains 01, byte 7 is the displacement factor field 1162B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1162B is a reinterpretation of disp8; when using displacement factor field 1162B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1162B substitutes the legacy x86 instruction set 8-bit displacement. Thus, the displacement factor field 1162B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 1172 operates as previously described.

### Full Opcode Field

FIG. 12B is a block diagram illustrating the fields of the specific vector friendly instruction format 1200 that make up the full opcode field 1174 according to one embodiment of the disclosure. Specifically, the full opcode field 1174 includes the format field 1140, the base operation field 1142, and the data element width (W) field 1164. The base operation field 1142 includes the prefix encoding field 1225, the opcode map field 1215, and the real opcode field 1230.

### Register Index Field

FIG. 12C is a block diagram illustrating the fields of the specific vector friendly instruction format 1200 that make up the register index field 1144 according to one embodiment of the disclosure. Specifically, the register index field 1144 includes the REX field 1205, the REX′ field 1210, the MODR/M.reg field 1244, the MODR/M.r/m field 1246, the VVVV field 1220, xxx field 1254, and the bbb field 1256.

### Augmentation Operation Field

FIG. 12D is a block diagram illustrating the fields of the specific vector friendly instruction format 1200 that make up the augmentation operation field 1150 according to one embodiment of the disclosure. When the class (U) field 1168 contains 0, it signifies EVEX.U0 (class A 1168A); when it contains 1, it signifies EVEX.U1 (class B 1168B). When U=0 and the MOD field 1242 contains 11 (signifying a no memory access operation), the alpha field 1152 (EVEX byte 3, bit [7]—EH) is interpreted as the rs field 1152A. When the rs field 1152A contains a 1 (round 1152A.1), the beta field 1154 (EVEX byte 3, bits [6:4]—SSS) is interpreted as the round control field 1154A. The round control field 1154A includes a one bit SAE field 1156 and a two bit round operation field 1158. When the rs field 1152A contains a 0 (data transform 1152A.2), the beta field 1154 (EVEX byte 3, bits [6:4]—SSS) is interpreted as a three bit data transform field 1154B. When U=0 and the MOD field 1242 contains 00, 01, or 10 (signifying a memory access operation), the alpha field 1152 (EVEX byte 3, bit [7]—EH) is interpreted as the eviction hint (EH) field 1152B and the beta field 1154 (EVEX byte 3, bits [6:4]—SSS) is interpreted as a three bit data manipulation field 1154C.

When U=1, the alpha field 1152 (EVEX byte 3, bit [7]—EH) is interpreted as the write mask control (Z) field 1152C. When U=1 and the MOD field 1242 contains 11 (signifying a no memory access operation), part of the beta field 1154 (EVEX byte 3, bit [4]—S₀) is interpreted as the RL field 1157A; when it contains a 1 (round 1157A.1) the rest of the beta field 1154 (EVEX byte 3, bit [6-5]—S₂₋₁) is interpreted as the round operation field 1159A, while when the RL field 1157A contains a 0 (VSIZE 1157.A2) the rest of the beta field 1154 (EVEX byte 3, bit [6-5]—S₂₋₁) is interpreted as the vector length field 1159B (EVEX byte 3, bit [6-5]—L₁₋₀). When U=1 and the MOD field 1242 contains 00, 01, or 10 (signifying a memory access operation), the beta field 1154 (EVEX byte 3, bits [6:4]—SSS) is interpreted as the vector length field 1159B (EVEX byte 3, bit [6-5]—L₁₋₀) and the broadcast field 1157B (EVEX byte 3, bit [4]—B).

### Exemplary Register Architecture

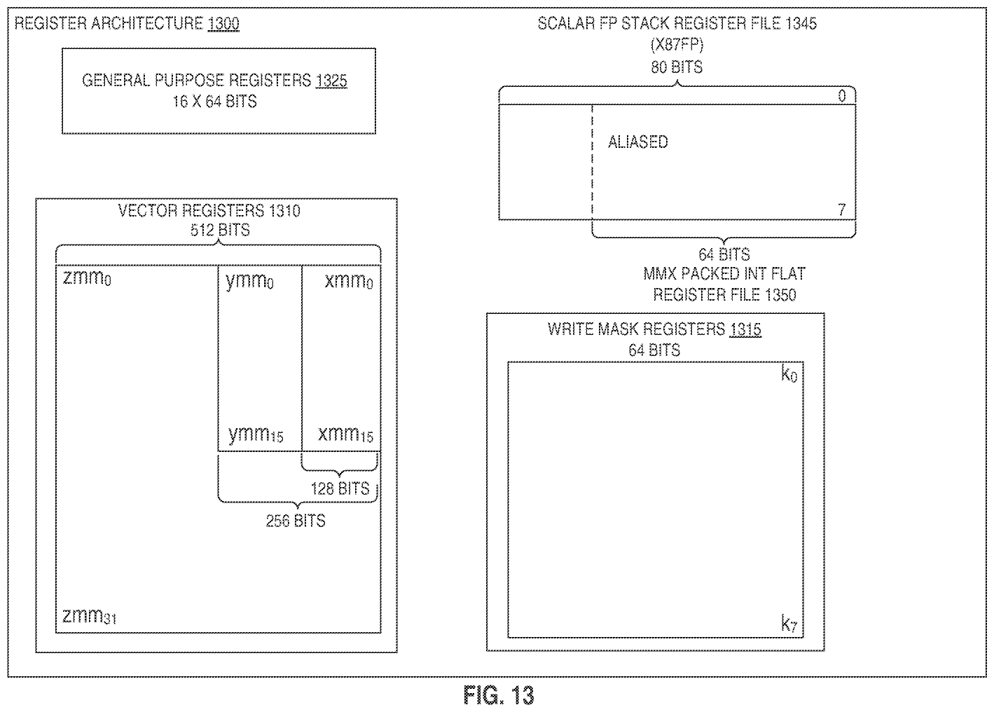

FIG. 13 is a block diagram of a register architecture 1300 according to one embodiment of the disclosure. In the embodiment illustrated, there are 32 vector registers 1310 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1200 operates on these overlaid register file as illustrated in the below tables.

| Adjustable Vector | | | |
|---|---|---|---|
| Length | Class | Operations | Registers |
| Instruction Templates | A | 1110, 1115, | zmm registers (the |
| that do not include the | (FIG. 11A; | 1125, 1130 | vector length is 64 |
| vector length field | U = 0) | | byte) |
| 1159B | B | 1112 | zmm registers (the |
| | (FIG. 11B; | | vector length is 64 |
| | U = 1) | | byte) |
| Instruction templates | B | 1117, 1127 | zmm, ymm, or xmm |
| that do include the | (FIG. 11B; | | registers (the vector |
| vector length field | U = 1) | | length is 64 byte, 32 |
| 1159B | | | byte, or 16 byte) |
| | | | depending on the |
| | | | vector length field |
| | | | 1159B |

In other words, the vector length field 1159B selects between a maximum length and one or more other shorter lengths, where each such shorter length is half the length of the preceding length; and instructions templates without the vector length field 1159B operate on the maximum vector length. Further, in one embodiment, the class B instruction templates of the specific vector friendly instruction format 1200 operate on packed or scalar single/double-precision floating point data and packed or scalar integer data. Scalar operations are operations performed on the lowest order data element position in a zmm/ymm/xmm register; the higher order data element positions are either left the same as they were prior to the instruction or zeroed depending on the embodiment.

Write mask registers 1315—in the embodiment illustrated, there are 8 write mask registers (k0 through k7), each 64 bits in size. In an alternate embodiment, the write mask registers 1315 are 16 bits in size. As previously described, in one embodiment of the disclosure, the vector mask register k0 cannot be used as a write mask; when the encoding that would normally indicate k0 is used for a write mask, it selects a hardwired write mask of 0xFFFF, effectively disabling write masking for that instruction.

General-purpose registers 1325—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1345, on which is aliased the MMX packed integer flat register file 1350—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the NMMX and XMM registers.

Alternative embodiments of the disclosure may use wider or narrower registers. Additionally, alternative embodiments of the disclosure may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

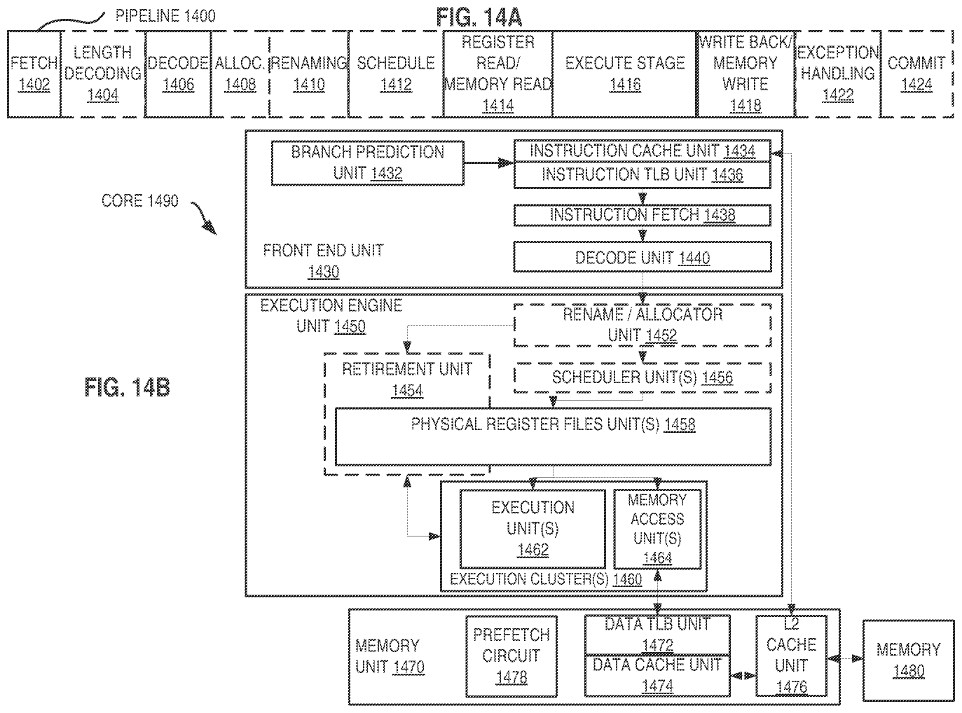

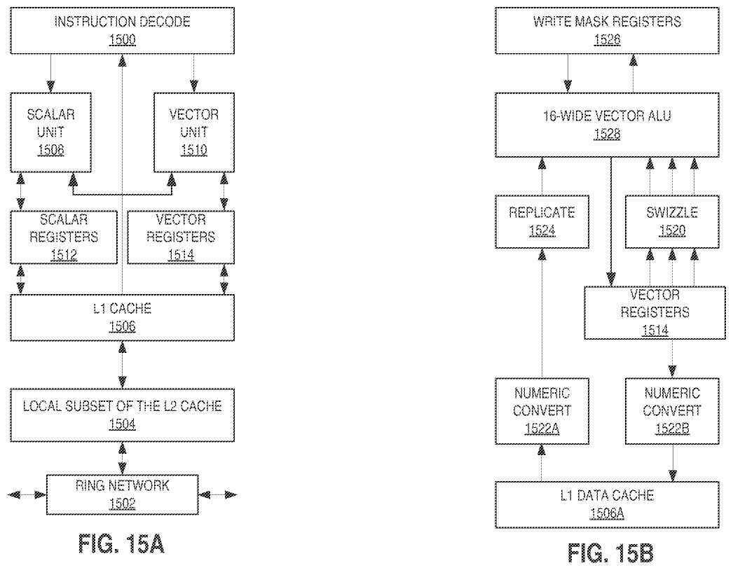

FIG. 14A is a block diagram illustrating both an exemplary in-order pipeline and an exemplary register renaming, out-of-order issue/execution pipeline according to embodiments of the disclosure. FIG. 14B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 14A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14A, a processor pipeline 1400 includes a fetch stage 1402, a length decode stage 1404, a decode stage 1406, an allocation stage 1408, a renaming stage 1410, a scheduling (also known as a dispatch or issue) stage 1412, a register read/memory read stage 1414, an execute stage 1416, a write back/memory write stage 1418, an exception handling stage 1422, and a commit stage 1424.

FIG. 14B shows processor core 1490 including a front-end unit 1430 coupled to an execution engine unit 1450, and both are coupled to a memory unit 1470. The core 1490 may be a reduced instruction set computing (RISC) core, a complex instruction set computing (CISC) core, a very long instruction word (VLIW) core, or a hybrid or alternative core type. As yet another option, the core 1490 may be a special-purpose core, such as, for example, a network or communication core, compression engine, coprocessor core, general purpose computing graphics processing unit (GPGPU) core, graphics core, or the like.

The front-end unit 1430 includes a branch prediction unit 1432 coupled to an instruction cache unit 1434, which is coupled to an instruction translation lookaside buffer (TLB) 1436, which is coupled to an instruction fetch unit 1438, which is coupled to a decode unit 1440. The decode unit 1440 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 1440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1490 includes a microcode ROM or other medium that stores microcode for certain macro-instructions (e.g., in decode unit 1440 or otherwise within the front-end unit 1430). The decode unit 1440 is coupled to a rename/allocator unit 1452 in the execution engine unit 1450.

The execution engine unit 1450 includes the rename/allocator unit 1452 coupled to a retirement unit 1454 and a set of one or more scheduler unit(s) 1456. The scheduler unit(s) 1456 represents any number of different schedulers, including reservations stations, central instruction window, etc. The scheduler unit(s) 1456 is coupled to the physical register file(s) unit(s) 1458. Each of the physical register file(s) units 1458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1458 comprises a vector registers unit, a write mask registers unit, and a scalar registers unit. These register units may provide architectural vector registers, vector mask registers, and general-purpose registers. The physical register file(s) unit(s) 1458 is overlapped by the retirement unit 1454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1454 and the physical register file(s) unit(s) 1458 are coupled to the execution cluster(s) 1460. The execution cluster(s) 1460 includes a set of one or more execution units 1462 and a set of one or more memory access units 1464. The execution units 1462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1456, physical register file(s) unit(s) 1458, and execution cluster(s) 1460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1464). It should also be understood that where separate pipelines are used, one or more of these pipelines may be out-of-order issue/execution and the rest in-order.

The set of memory access units 1464 is coupled to the memory unit 1470, which includes a data TLB unit 1472 coupled to a data cache unit 1474 coupled to a level 2 (L2) cache unit 1476. In one exemplary embodiment, the memory access units 1464 may include a load unit, a store address unit, and a store data unit, each of which is coupled to the data TLB unit 1472 in the memory unit 1470. The instruction cache unit 1434 is further coupled to a level 2 (L2) cache unit 1476 in the memory unit 1470. The L2 cache unit 1476 is coupled to one or more other levels of cache and eventually to a main memory.

In certain embodiments, a prefetch circuit 1478 is included to prefetch data, for example, to predict access addresses and bring the data for those addresses into a cache or caches (e.g., from memory 1480).

By way of example, the exemplary register renaming, out-of-order issue/execution core architecture may implement the pipeline 1400 as follows: 1) the instruction fetch 1438 performs the fetch and length decoding stages 1402 and 1404; 2) the decode unit 1440 performs the decode stage 1406; 3) the rename/allocator unit 1452 performs the allocation stage 1408 and renaming stage 1410; 4) the scheduler unit(s) 1456 performs the schedule stage 1412; 5) the physical register file(s) unit(s) 1458 and the memory unit 1470 perform the register read/memory read stage 1414; the execution cluster 1460 perform the execute stage 1416; 6) the memory unit 1470 and the physical register file(s) unit(s) 1458 perform the write back/memory write stage 1418; 7) various units may be involved in the exception handling stage 1422; and 8) the retirement unit 1454 and the physical register file(s) unit(s) 1458 perform the commit stage 1424.

The core 1490 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyper-Threading technology).

While register renaming is described in the context of out-of-order execution, it should be understood that register renaming may be used in an in-order architecture. While the illustrated embodiment of the processor also includes separate instruction and data cache units 1434/1474 and a shared L2 cache unit 1476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

FIGS. 15A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 15A is a block diagram of a single processor core, along with its connection to the on-die interconnect network 1502 and with its local subset of the Level 2 (L2) cache 1504, according to embodiments of the disclosure. In one embodiment, an instruction decode unit 1500 supports the x86 instruction set with a packed data instruction set extension. An L1 cache 1506 allows low-latency accesses to cache memory into the scalar and vector units. While in one embodiment (to simplify the design), a scalar unit 1508 and a vector unit 1510 use separate register sets (respectively, scalar registers 1512 and vector registers 1514) and data transferred between them is written to memory and then read back in from a level 1 (L1) cache 1506, alternative embodiments of the disclosure may use a different approach (e.g., use a single register set or include a communication path that allow data to be transferred between the two register files without being written and read back).

The local subset of the L2 cache 1504 is part of a global L2 cache that is divided into separate local subsets, one per processor core. Each processor core has a direct access path to its own local subset of the L2 cache 1504. Data read by a processor core is stored in its L2 cache subset 1504 and can be accessed quickly, in parallel with other processor cores accessing their own local L2 cache subsets. Data written by a processor core is stored in its own L2 cache subset 1504 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 15B is an expanded view of part of the processor core in FIG. 15A according to embodiments of the disclosure. FIG. 15B includes an L1 data cache 1506A part of the L1 cache 1504, as well as more detail regarding the vector unit 1510 and the vector registers 1514. Specifically, the vector unit 1510 is a 16-wide vector processing unit (VPU) (see the 16-wide ALU 1528), which executes one or more of integer, single-precision float, and double-precision float instructions. The VPU supports swizzling the register inputs with swizzle unit 1520, numeric conversion with numeric convert units 1522A-B, and replication with replication unit 1524 on the memory input. Write mask registers 1526 allow predicating resulting vector writes.

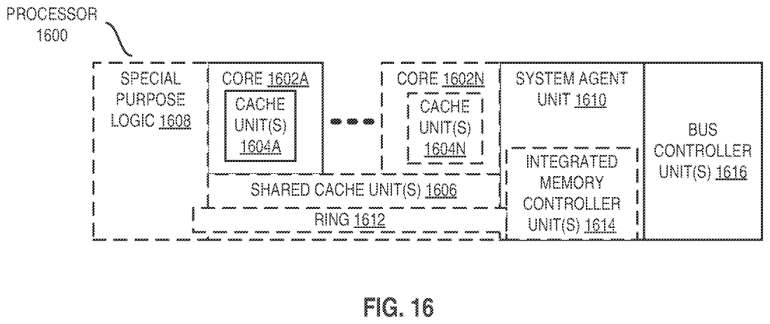

FIG. 16 is a block diagram of a processor 1600 that may have more than one core, may have an integrated memory controller, and may have integrated graphics according to embodiments of the disclosure. The solid lined boxes in FIG. 16 illustrate a processor 1600 with a single core 1602A, a system agent 1610, a set of one or more bus controller units 1616, while the optional addition of the dashed lined boxes illustrates an alternative processor 1600 with multiple cores 1602A-N, a set of one or more integrated memory controller unit(s) 1614 in the system agent unit 1610, and special purpose logic 1608.

Thus, different implementations of the processor 1600 may include: 1) a CPU with the special purpose logic 1608 being integrated graphics and/or scientific (throughput) logic (which may include one or more cores), and the cores 1602A-N being one or more general purpose cores (e.g., general purpose in-order cores, general purpose out-of-order cores, a combination of the two); 2) a coprocessor with the cores 1602A-N being a large number of special purpose cores intended primarily for graphics and/or scientific (throughput); and 3) a coprocessor with the cores 1602A-N being a large number of general purpose in-order cores. Thus, the processor 1600 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1600 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1606, and external memory (not shown) coupled to the set of integrated memory controller units 1614. The set of shared cache units 1606 may include one or more mid-level caches, such as level 2 (L2), level 3 (L3), level 4 (L4), or other levels of cache, a last level cache (LLC), and/or combinations thereof. While in one embodiment a ring-based interconnect unit 1612 interconnects the integrated graphics logic 1608, the set of shared cache units 1606, and the system agent unit 1610/integrated memory controller unit(s) 1614, alternative embodiments may use any number of well-known techniques for interconnecting such units. In one embodiment, coherency is maintained between one or more cache units 1606 and cores 1602-A-N.

In some embodiments, one or more of the cores 1602A-N are capable of multi-threading. The system agent 1610 includes those components coordinating and operating cores 1602A-N. The system agent unit 1610 may include for example a power control unit (PCU) and a display unit. The PCU may be or include logic and components needed for regulating the power state of the cores 1602A-N and the integrated graphics logic 1608. The display unit is for driving one or more externally connected displays.

The cores 1602A-N may be homogenous or heterogeneous in terms of architecture instruction set; that is, two or more of the cores 1602A-N may be capable of execution the same instruction set, while others may be capable of executing only a subset of that instruction set or a different instruction set.

### Exemplary Computer Architectures

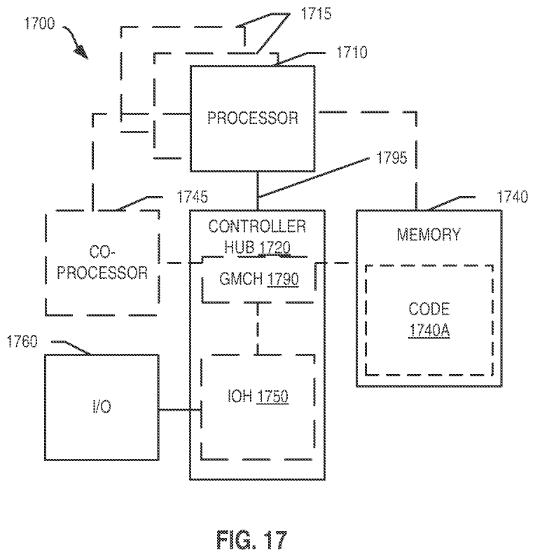

FIGS. 17-20 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 17, shown is a block diagram of a system 1700 in accordance with one embodiment of the present disclosure. The system 1700 may include one or more processors 1710, 1715, which are coupled to a controller hub 1720. In one embodiment the controller hub 1720 includes a graphics memory controller hub (GMCH) 1790 and an Input/Output Hub (IOH) 1750 (which may be on separate chips); the GMCH 1790 includes memory and graphics controllers to which are coupled memory 1740 and a coprocessor 1745; the IOH 1750 is couples input/output (I/O) devices 1760 to the GMCH 1790. Alternatively, one or both of the memory and graphics controllers are integrated within the processor (as described herein), the memory 1740 and the coprocessor 1745 are coupled directly to the processor 1710, and the controller hub 1720 in a single chip with the IOH 1750. Memory 1740 may include code 1740A, for example, that when executed causes a processor to perform any method of this disclosure.

The optional nature of additional processors 1715 is denoted in FIG. 17 with broken lines. Each processor 1710, 1715 may include one or more of the processing cores described herein and may be some version of the processor 1600.

The memory 1740 may be, for example, dynamic random-access memory (DRAM), phase change memory (PCM), or a combination of the two. For at least one embodiment, the controller hub 1720 communicates with the processor(s) 1710, 1715 via a multi-drop bus, such as a frontside bus (FSB), point-to-point interface such as Quickpath Interconnect (QPI), or similar connection 1795.

In one embodiment, the coprocessor 1745 is a special-purpose processor, such as, for example, a high-throughput MIC processor, a network or communication processor, compression engine, graphics processor, GPGPU, embedded processor, or the like. In one embodiment, controller hub 1720 may include an integrated graphics accelerator.

There can be a variety of differences between the physical resources 1710, 1715 in terms of a spectrum of metrics of merit including architectural, microarchitectural, thermal, power consumption characteristics, and the like.

In one embodiment, the processor 1710 executes instructions that control data processing operations of a general type. Embedded within the instructions may be coprocessor instructions. The processor 1710 recognizes these coprocessor instructions as being of a type that should be executed by the attached coprocessor 1745. Accordingly, the processor 1710 issues these coprocessor instructions (or control signals representing coprocessor instructions) on a coprocessor bus or other interconnect, to coprocessor 1745. Coprocessor(s) 1745 accept and execute the received coprocessor instructions.

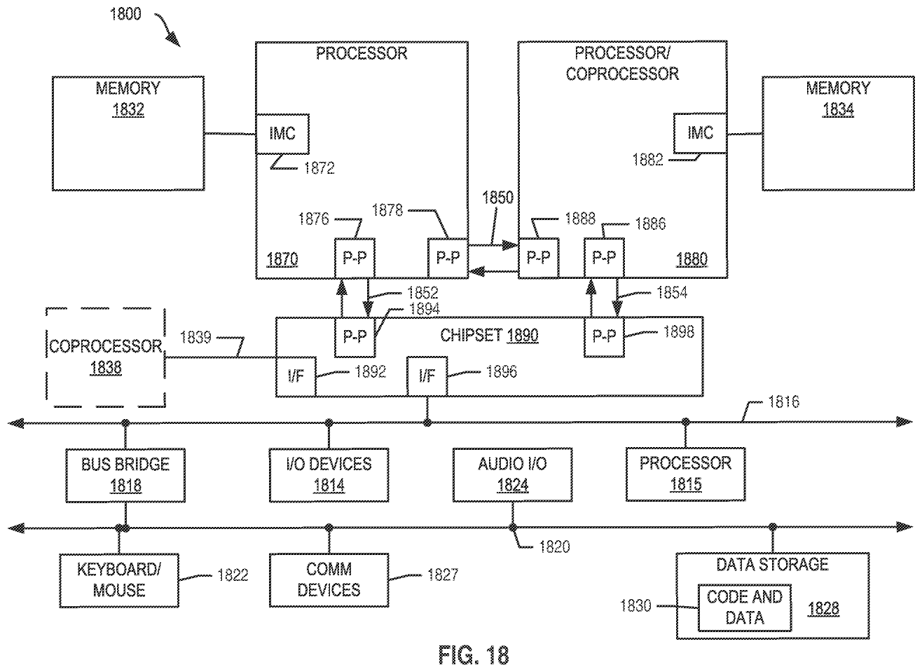

Referring now to FIG. 18, shown is a block diagram of a first more specific exemplary system 1800 in accordance with an embodiment of the present disclosure. As shown in FIG. 18, multiprocessor system 1800 is a point-to-point interconnect system, and includes a first processor 1870 and a second processor 1880 coupled via a point-to-point interconnect 1850. Each of processors 1870 and 1880 may be some version of the processor 1600. In one embodiment of the disclosure, processors 1870 and 1880 are respectively processors 1710 and 1715, while coprocessor 1838 is coprocessor 1745. In another embodiment, processors 1870 and 1880 are respectively processor 1710 coprocessor 1745.

Processors 1870 and 1880 are shown including integrated memory controller (IMC) units 1872 and 1882, respectively. Processor 1870 also includes as part of its bus controller units point-to-point (P-P) interfaces 1876 and 1878; similarly, second processor 1880 includes P-P interfaces 1886 and 1888. Processors 1870, 1880 may exchange information via a point-to-point (P-P) interface 1850 using P-P interface circuits 1878, 1888. As shown in FIG. 18, IMCs 1872 and 1882 couple the processors to respective memories, namely a memory 1832 and a memory 1834, which may be portions of main memory locally attached to the respective processors.

Processors 1870, 1880 may each exchange information with a chipset 1890 via individual P-P interfaces 1852, 1854 using point to point interface circuits 1876, 1894, 1886, 1898. Chipset 1890 may optionally exchange information with the coprocessor 1838 via a high-performance interface 1839. In one embodiment, the coprocessor 1838 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1890 may be coupled to a first bus 1816 via an interface 1896. In one embodiment, first bus 1816 may be a Peripheral Component Interconnect (PCI) bus, or a bus such as a PCI Express bus or another third generation I/O interconnect bus, although the scope of the present disclosure is not so limited.

As shown in FIG. 18, various I/O devices 1814 may be coupled to first bus 1816, along with a bus bridge 1818 which couples first bus 1816 to a second bus 1820. In one embodiment, one or more additional processor(s) 1815, such as coprocessors, high-throughput MIC processors, GPGPU's, accelerators (such as, e.g., graphics accelerators or digital signal processing (DSP) units), field programmable gate arrays, or any other processor, are coupled to first bus 1816. In one embodiment, second bus 1820 may be a low pin count (LPC) bus. Various devices may be coupled to a second bus 1820 including, for example, a keyboard and/or mouse 1822, communication devices 1827 and a storage unit 1828 such as a disk drive or other mass storage device which may include instructions/code and data 1830, in one embodiment. Further, an audio I/O 1824 may be coupled to the second bus 1820. Note that other architectures are possible. For example, instead of the point-to-point architecture of FIG. 18, a system may implement a multi-drop bus or other such architecture.

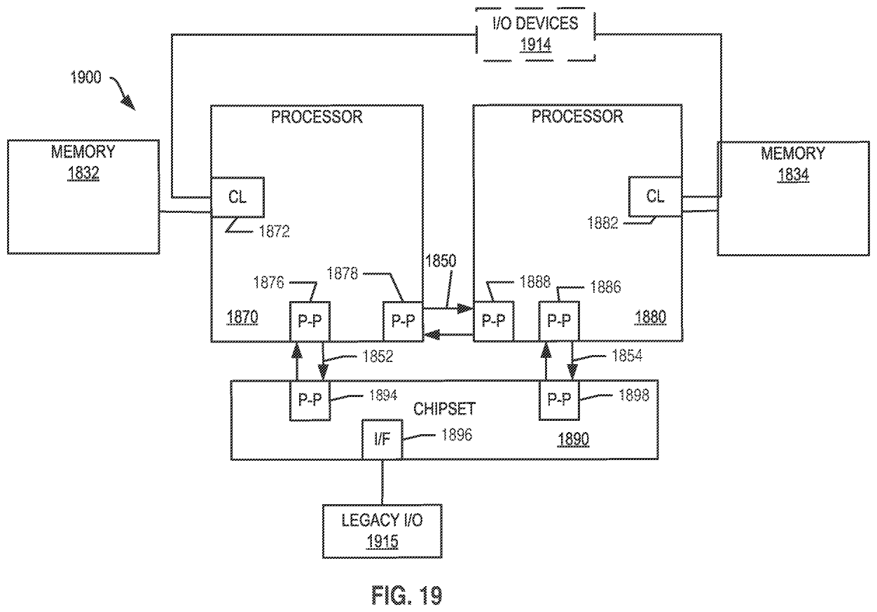

Referring now to FIG. 19, shown is a block diagram of a second more specific exemplary system 1900 in accordance with an embodiment of the present disclosure. Like elements in FIGS. 18 and 19 bear like reference numerals, and certain aspects of FIG. 18 have been omitted from FIG. 19 in order to avoid obscuring other aspects of FIG. 19.

FIG. 19 illustrates that the processors 1870, 1880 may include integrated memory and I/O control logic (“CL”) 1872 and 1882, respectively. Thus, the CL 1872, 1882 include integrated memory controller units and include I/O control logic. FIG. 19 illustrates that not only are the memories 1832, 1834 coupled to the CL 1872, 1882, but also that I/O devices 1914 are also coupled to the control logic 1872, 1882. Legacy I/O devices 1915 are coupled to the chipset 1890.

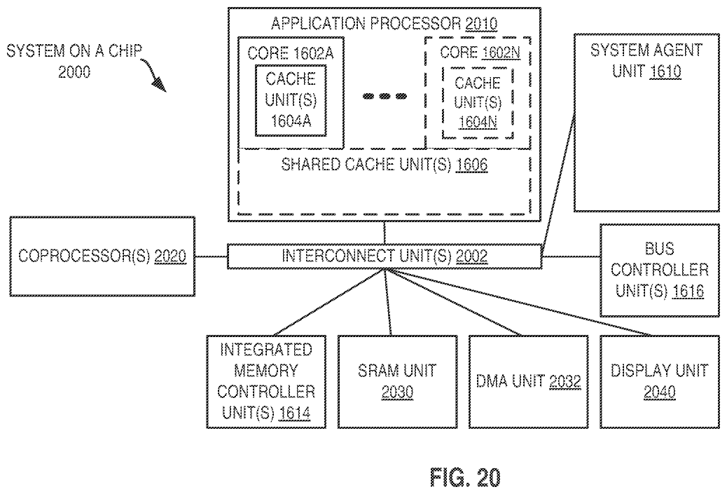

Referring now to FIG. 20, shown is a block diagram of a SoC 2000 in accordance with an embodiment of the present disclosure. Similar elements in FIG. 16 bear like reference numerals. Also, dashed lined boxes are optional features on more advanced SoCs. In FIG. 20, an interconnect unit(s) 2002 is coupled to: an application processor 2010 which includes a set of one or more cores 202A-N and shared cache unit(s) 1606; a system agent unit 1610; a bus controller unit(s) 1616; an integrated memory controller unit(s) 1614; a set or one or more coprocessors 2020 which may include integrated graphics logic, an image processor, an audio processor, and a video processor; an static random access memory (SRAM) unit 2030; a direct memory access (DMA) unit 2032; and a display unit 2040 for coupling to one or more external displays. In one embodiment, the coprocessor(s) 2020 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1830 illustrated in FIG. 18, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

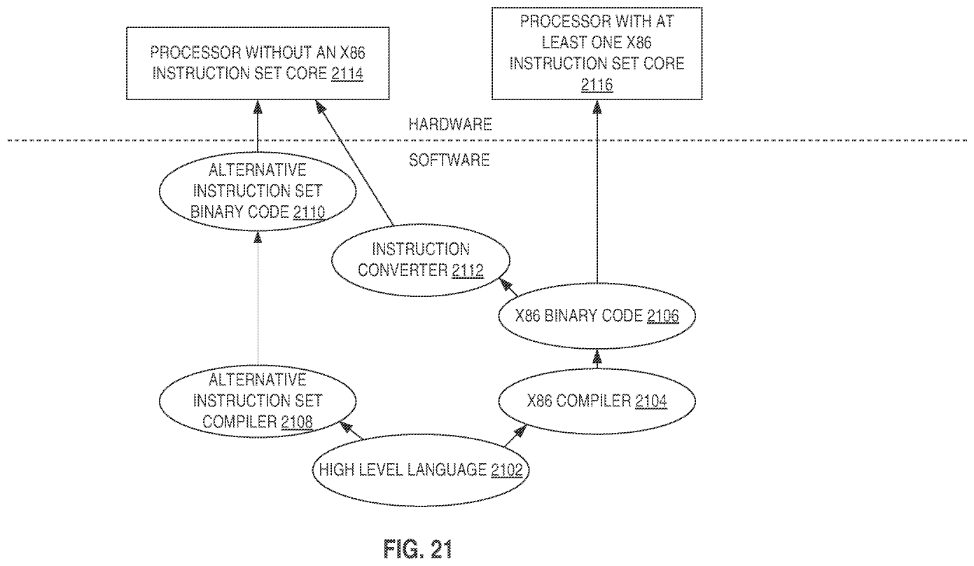

FIG. 21 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 21 shows a program in a high-level language 2102 may be compiled using an x86 compiler 2104 to generate x86 binary code 2106 that may be natively executed by a processor with at least one x86 instruction set core 2116. The processor with at least one x86 instruction set core 2116 represents any processor that can perform substantially the same functions as an Intel® processor with at least one x86 instruction set core by compatibly executing or otherwise processing (1) a substantial portion of the instruction set of the Intel® x86 instruction set core or (2) object code versions of applications or other software targeted to run on an Intel® processor with at least one x86 instruction set core, in order to achieve substantially the same result as an Intel® processor with at least one x86 instruction set core. The x86 compiler 2104 represents a compiler that is operable to generate x86 binary code 2106 (e.g., object code) that can, with or without additional linkage processing, be executed on the processor with at least one x86 instruction set core 2116. Similarly, FIG. 21 shows the program in the high level language 2102 may be compiled using an alternative instruction set compiler 2108 to generate alternative instruction set binary code 2110 that may be natively executed by a processor without at least one x86 instruction set core 2114 (e.g., a processor with cores that execute the MIPS instruction set of MIPS Technologies of Sunnyvale, CA and/or that execute the ARM instruction set of ARM Holdings of Sunnyvale, CA). The instruction converter 2112 is used to convert the x86 binary code 2106 into code that may be natively executed by the processor without an x86 instruction set core 2114. This converted code is not likely to be the same as the alternative instruction set binary code 2110 because an instruction converter capable of this is difficult to make; however, the converted code will accomplish the general operation and be made up of instructions from the alternative instruction set. Thus, the instruction converter 2112 represents software, firmware, hardware, or a combination thereof that, through emulation, simulation, or any other process, allows a processor or other electronic device that does not have an x86 instruction set processor or core to execute the x86 binary code 2106.

1. An apparatus comprising:
an input/output memory controller to perform a direct memory access of a memory for an input/output device separate from a processor core; and
the processor core comprising:
a decoder circuit to decode a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device, and
the execution circuit to execute the decoded single instruction according to the opcode.

2. The apparatus of claim 1, wherein the opcode is to indicate the execution circuit is to cause the input/output memory controller to send a message to the input/output device that identifies the virtual address to physical address mapping.

3. The apparatus of claim 2, wherein the message further comprises a process address space identifier.

4. The apparatus of claim 3, wherein the opcode is to indicate the execution circuit is to determine the process address space identifier from a process address space identifier register of the processor core.

5. The apparatus of claim 1, wherein the one or more fields are to identify a device identification value of the input/output device.

6. The apparatus of claim 1, wherein the opcode is to indicate the execution circuit is to cause the input/output memory controller to perform a page walk of the memory to determine the virtual address to physical address mapping.

7. The apparatus of claim 6, wherein the input/output device comprises a register, that when written with a value by execution of the single instruction, causes the input/output memory controller to perform the page walk.

8. The apparatus of claim 1, wherein the opcode is to indicate the execution circuit is to cause the input/output memory controller to add an entry into a secure address translation service data structure of the input/output memory controller that indicates the input/output device is allowed to access the physical address in the memory.

9. A method comprising:
decoding, by a processor core of a system that is separate from an input/output device of the system coupled to an input/output memory controller of the system to perform a direct memory access of a memory for the input/output device, a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device; and
executing the decoded single instruction by the execution circuit according to the opcode.

10. The method of claim 9, wherein the opcode is to indicate the execution circuit is to cause the input/output memory controller to send a message to the input/output device that identifies the virtual address to physical address mapping.

11. The method of claim 10, wherein the message further comprises a process address space identifier.

12. The method of claim 11, wherein the opcode is to indicate the execution circuit is to determine the process address space identifier from a process address space identifier register of the processor core.

13. The method of claim 9, wherein the one or more fields are to identify a device identification value of the input/output device.

14. The method of claim 9, wherein the opcode is to indicate the execution circuit is to cause the input/output memory controller to perform a page walk of the memory to determine the virtual address to physical address mapping.

15. The method of claim 14, wherein the input/output device comprises a register, that when written with a value by the executing of the single instruction, causes the input/output memory controller to perform the page walk.

16. The method of claim 9, wherein the opcode is to indicate the execution circuit is to cause the input/output memory controller to add an entry into a secure address translation service data structure of the input/output memory controller that indicates the input/output device is allowed to access the physical address in the memory.

17. A system comprising:
an input/output device;
an input/output memory controller to perform a direct memory access of a memory for the input/output device; and
a processor core separate from the input/output device and comprising:
a decoder circuit to decode a single instruction into a decoded single instruction, the single instruction including one or more fields to identify a virtual address to physical address mapping for the input/output device in the memory, and an opcode to indicate an execution circuit is to store the virtual address to physical address mapping into a translation lookaside buffer within the input/output device, and
the execution circuit to execute the decoded single instruction according to the opcode.

18. The system of claim 17, wherein the opcode is to indicate the execution circuit is to cause the input/output memory controller to send a message to the input/output device that identifies the virtual address to physical address mapping.

19. The system of claim 18, wherein the message further comprises a process address space identifier.

20. The system of claim 19, wherein the opcode is to indicate the execution circuit is to determine the process address space identifier from a process address space identifier register of the processor core.

21.-24. (canceled)
